(19) United States
(12) Patent Application Publication
(10) Pub. No.: US 2024/0036590 A1
(43) Pub. Date: Feb. 1, 2024

(54) NAVIGATION CONTROL FOR OBSTACLES AVOIDANCE IN AERIAL NAVIGATION SYSTEM

(71) Applicant: Everseen Limited, Blackpool (IE)

(72) Inventors: Cosmin Cernazanu-Glavan, Timisoara (RO); Dan Alexandru Pescaru, Timisoara (RO); Vasile Gui, Timisoara (RO); Ciprian David, Timisoara (RO)

(21) Appl. No.: 17/877,453

(22) Filed: Jul. 29, 2022

(51) Int. Cl. B64C 39/02; G05D 1/10

(52) U.S. Cl. CPC B64C 39/024; G05D 1/101; B64C 2201/127

(57) ABSTRACT

A system and a method for navigating an aerial robotic device movable within an aerial movement volume are provided. The method comprises generating a global environment map of the aerial movement volume, and detecting static obstacles therefrom. The method further comprises generating a depth map detailing presence or absence of objects with reference to a current location of the aerial robotic device, and detecting dynamic obstacles therefrom. The method further comprises re-scaling the depth map to correspond to the global environment map of the aerial movement volume, and tracing a route for the aerial robotic device from the current location to the target location avoiding the one or more static obstacles and the one or more dynamic obstacles. The method further comprises navigating the aerial robotic device based on the traced route to enable the aerial robotic device from the current location to the target location.

### TECHNICAL FIELD

The present disclosure relates generally to navigation control in aerial navigation system. More particularly, the present disclosure relates to an aerial navigation system and a method for navigation control therefor, for avoidance of stationary and moving obstacles for its movement within a defined movement volume using reinforced machine learning.

### BACKGROUND

An unmanned aerial vehicle (UAV) (or uncrewed aerial vehicle, commonly known as a drone) is an aircraft without a human pilot on board and a type of unmanned vehicle. UAVs are a component of an unmanned aircraft system (UAS), which include a UAV, a ground-based controller, and a system of communications between the two. The flight of UAVs may operate with various degrees of autonomy, either under remote control by a human operator or autonomously by onboard computers. Further, traditional wired aerial robotic devices require manual control of their movements by a trained operator using a joystick apparatus. However, such manual control is an overly labor-intensive process and requires significant motor skills on the part of the human operator, especially when required to navigate from one location to another while avoiding any static and/or dynamic obstacles in a route of the aerial vehicle.

### SUMMARY

In one aspect of the present disclosure, there is provided an aerial navigation system. The aerial navigation system comprises an aerial robotic device moveable within an aerial movement volume and comprising one or more depth detecting sensors configured to capture image frames of a vicinity of the aerial robotic device within a field of view thereof. The aerial navigation system further comprises a navigation control unit for navigating the aerial robotic device in the aerial movement volume. The navigation control unit is configured to define a target location for the aerial robotic device in the aerial movement volume. The navigation control unit is further configured to perform a survey of the aerial movement volume by the aerial robotic device in accordance with a pre-defined movement schema to generate a global environment map of the aerial movement volume. The navigation control unit is further configured to analyze the global environment map to detect one or more static obstacles in the aerial movement volume. The navigation control unit is further configured to stitch the captured image frames of the vicinity of the aerial robotic device to generate a depth map detailing presence or absence of objects with reference to a current location of the aerial robotic device. The navigation control unit is further configured to analyze the depth map to detect one or more dynamic obstacles in the vicinity of the aerial robotic device. The navigation control unit is further configured to re-scale the depth map to correspond to the global environment map of the aerial movement volume, wherein the current location of the aerial robotic device is represented as a co-ordinate in the global environment map. The navigation control unit is further configured to trace a route for the aerial robotic device from the current location to the target location based on the detected one or more dynamic obstacles and the detected one or more detected static obstacles. The navigation control unit is further configured to navigate the aerial robotic device based on the traced route from the current location to the target location.

In one or more embodiments, the navigation control unit is configured to implement a neural network to trace the route, wherein the neural network is pre-trained to avoid collision with obstacles during navigation of the aerial robotic device.

In one or more embodiments, the navigation control unit is configured to pre-train the neural network by simulating the aerial movement volume; generating obstacles of different sizes at different locations in the simulated aerial movement volume; and executing simulation scenarios to generate training data for the neural network.

In one or more embodiments, the neural network is based on deep Q-learning reinforcement algorithm.

In one or more embodiments, a reward for the neural network is expressed as a shortest distance navigation path between the current location of the aerial robotic device and the target location avoiding the one or more static obstacles and the one or more dynamic obstacles therebetween.

In one or more embodiments, the aerial robotic device is suspended from a vertical wire connected to a carrier device. The aerial navigation system further comprises a plurality of electric motors mounted on upright members at a substantially same height from a ground and configured to drive the carrier device through a set of horizontal wires in a bounded horizontal plane mutually subtended by the plurality of electric motors, and at least one electric motor configured to drive the aerial robotic device with respect to the carrier device through the vertical wire, and wherein the aerial robotic device is moveable within an aerial movement volume defined between the ground, the plurality of upright members and the horizontal plane.

In one or more embodiments, the navigation control unit is configured to determine control parameters for at least one of the plurality of electric motors driving the carrier device and the at least one motor driving the aerial robotic device with respect to the carrier device based on the traced route for the aerial robotic device. The navigation control unit is further configured to configure the plurality of electric motors driving the carrier device and the at least one motor driving the aerial robotic device with respect to the carrier device to operate based on the respective control parameters therefor, to navigate the aerial robotic device based on the traced route from the current location to the target location.

In one or more embodiments, the navigation control unit comprises a real-time synchronization interface for synchronizing movements of the plurality of electric motors driving the carrier device and the at least one motor driving the aerial robotic device with respect to the carrier device respectively based on the respective control parameters therefor.

In one or more embodiments, the pre-defined movement schema comprises a looped zig-zag movement pattern.

In one or more embodiments, the global environment map of the aerial movement volume is a binary-valued two dimensional map of the aerial movement volume.

In another aspect of the present disclosure, there is provided a method for navigating an aerial robotic device movable within an aerial movement volume. The aerial robotic device comprises one or more depth detecting sensors configured to capture image frames of a vicinity of the aerial robotic device within a field of view thereof. The method comprises defining a target location for the aerial robotic device in the aerial movement volume. The method further comprises performing a survey of the aerial movement volume by the aerial robotic device in accordance with a pre-defined movement schema to generate a global environment map of the aerial movement volume. The method further comprises analyzing the global environment map to detect one or more static obstacles in the aerial movement volume. The method further comprises stitching the captured image frames, by the one or more depth detecting sensors, to generate a depth map detailing presence or absence of objects with reference to a current location of the aerial robotic device. The method further comprises analyzing the depth map to detect one or more dynamic obstacles in a vicinity of the aerial robotic device. The method further comprises re-scaling the depth map to correspond to the global environment map of the aerial movement volume, wherein the current location of the aerial robotic device is represented as a co-ordinate in the global environment map. The method further comprises tracing a route for the aerial robotic device from the current location to the target location based on the detected one or more dynamic obstacles and the detected one or more detected static obstacles. The method further comprises navigating the aerial robotic device based on the traced route from the current location to the target location.

In one or more embodiments, tracing the route comprises implementing a neural network, wherein the neural network is pre-trained to avoid collision with detected obstacles during navigation of the aerial robotic device.

In one or more embodiments, pre-training the neural network comprises simulating the aerial movement volume; generating obstacles of different sizes at different locations in the simulated aerial movement volume; and executing simulation scenarios to generate training data for the neural network.

In one or more embodiments, the neural network is based on deep Q-learning reinforcement algorithm, and a reward for the neural network is expressed as a shortest distance navigation path between the current location of the aerial robotic device and the target location avoiding the one or more static obstacles and the one or more dynamic obstacles therebetween.

In one or more embodiments, the pre-defined movement scheme comprises a looped zig-zag movement pattern.

In one or more embodiments, the global environment map of the aerial movement volume is a binary-valued two dimensional map of the aerial movement volume.

In yet another aspect of the present disclosure, there is provided a navigation control unit for navigating an aerial robotic device movable within an aerial movement volume. The aerial robotic device comprising one or more depth detecting sensors configured to capture image frames of a vicinity of the aerial robotic device within a field of view thereof. The navigation control unit is configured to define a target location for the aerial robotic device in the aerial movement volume. The navigation control unit is further configured to perform a survey of the aerial movement volume by the aerial robotic device in accordance with a pre-defined movement schema to generate a global environment map of the aerial movement volume. The navigation control unit is further configured to analyze the global environment map to detect one or more static obstacles in the aerial movement volume. The navigation control unit is further configured to stitch the captured image frames of the vicinity of the aerial robotic device to generate a depth map detailing presence or absence of objects with reference to a current location of the aerial robotic device. The navigation control unit is further configured to analyze the depth map to detect one or more dynamic obstacles in the vicinity of the aerial robotic device. The navigation control unit is further configured to re-scale the depth map to correspond to the global environment map of the aerial movement volume, wherein the current location of the aerial robotic device is represented as a co-ordinate in the global environment map. The navigation control unit is further configured to trace a route for the aerial robotic device from the current location to the target location based on the detected one or more dynamic obstacles and the detected one or more detected static obstacles. The navigation control unit is further configured to navigate the aerial robotic device based on the traced route from the current location to the target location.

In one or more embodiments, the navigation control unit is further configured to implement a neural network to trace the route, wherein the neural network is pre-trained to avoid collision with obstacles during navigation of the aerial robotic device.

In one or more embodiments, the navigation control unit is further configured to pre-train the neural network by: simulating the aerial movement volume; generating obstacles of different sizes at different locations in the simulated aerial movement volume; and executing simulation scenarios to generate training data for the neural network.

In one or more embodiments, the neural network is based on deep Q-learning reinforcement algorithm, and wherein a reward for the neural network is expressed as a shortest distance navigation path between the current location of the aerial robotic device and the target location avoiding the one or more static obstacles and the one or more dynamic obstacles therebetween.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 is a diagrammatic illustration of an aerial navigation system, in accordance with an embodiment of the present disclosure;

FIG. 2 is a diagrammatic illustration of an aerial robotic device of the aerial navigation system of FIG. 1 depicting an arrangement of depth detecting sensors thereon, in accordance with an embodiment of the present disclosure;

FIG. 3 is an exemplary diagrammatic representation for determination of the co-ordinates of a Carrier Device of the aerial navigation system of FIG. 1 in a Two-Dimensional Carrier Device Reference System (2D-CDRS), in accordance with an embodiment of the present disclosure;

FIG. 4 is an exemplary diagrammatic representation for expansion of the 2D-CDRS of FIG. 3 into a Three Dimensional Navigation Reference System (3D-NRS), in accordance with an embodiment of the present disclosure;

FIG. 5 is an exemplary diagrammatic representation for determination of co-ordinates (x_{A′}, y_{A′}) of a second location A′ in the 3D-NRS of FIG. 4, in accordance with an embodiment of the present disclosure;

FIG. 6 is an exemplary diagrammatic representation of co-ordinates in an Aerial Robotic Device Reference System (ARDRS) being translated to co-ordinates in the 2D-CDRS of FIG. 3, in accordance with an embodiment of the present disclosure;

FIG. 7 is a schematic of software components of a navigation control unit of the aerial navigation system of FIG. 1, in accordance with an embodiment of the present disclosure;

FIG. 8 is a flowchart listing steps involved in a method for generating and updating a global environment map (GEM) of an aerial movement volume of the aerial navigation system of FIG. 1, and detecting static obstacles and dynamic obstacles in accordance with an embodiment of the present disclosure; and including steps from the method of navigating an aerial robotic device to a target location while avoiding intervening stationary and dynamic obstacles, of FIG. 18;

FIG. 9 is a depiction of an exemplary movement schema for the robotic aerial device, in accordance with an embodiment of the present disclosure;

FIG. 10 a depiction of an exemplary global environment map, in accordance with an embodiment of the present disclosure;

FIG. 11 is a block diagram depicting implementation of a stitching unit for depth detecting sensors of the aerial robotic device, in accordance with an embodiment of the present disclosure;

FIG. 12 is a depiction of an exemplary depth map, in accordance with an embodiment of the present disclosure;

FIG. 13 is a depiction illustrating visible zone and invisible zone for an aerial movement volume for the aerial robotic device, in accordance with an embodiment of the present disclosure;

FIG. 14 is a depiction illustrating potential directions of movement for the aerial robotic device, in accordance with an embodiment of the present disclosure;

FIG. 15 is a block diagram of an architecture of a neural network implemented by the navigation control unit, in accordance with an embodiment of the present disclosure;

FIG. 16 is a depiction of an exemplary cuboid representation of simulated obstacles, in accordance with an embodiment of the present disclosure;

FIGS. 17A and 17B are diagrammatic representation of simulated environments for training of the neural network architecture of FIG. 15, in accordance with an embodiment of the present disclosure; and

FIG. 18 is a flowchart listing steps involved in a method of navigating an aerial robotic device to a target location while avoiding intervening stationary and dynamic obstacles, in accordance with an embodiment of the present disclosure and including steps from the method for generating and updating a GEM of an aerial movement volume of the aerial navigation system of FIG. 1, and detecting static obstacles and dynamic obstacles of FIG. 8.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

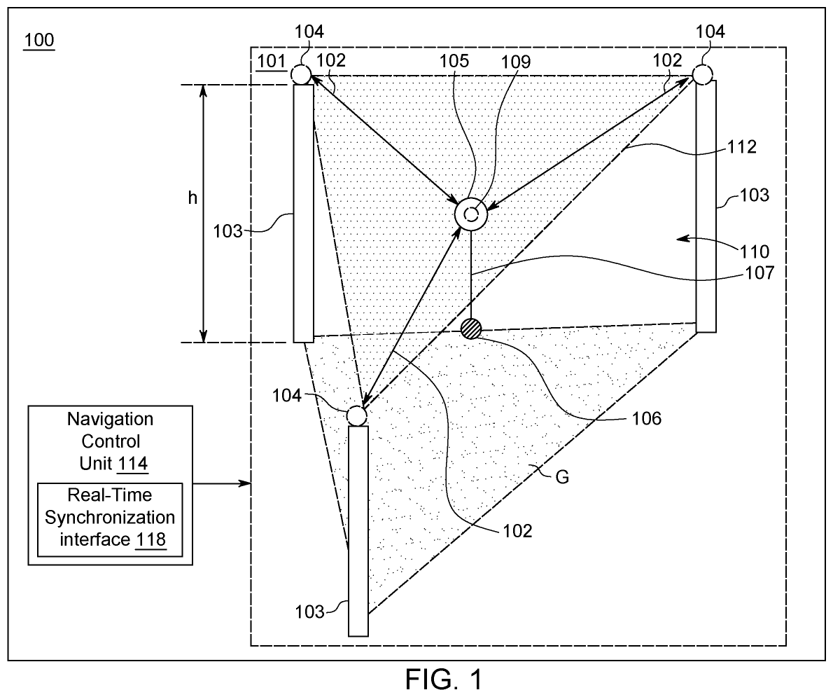

Referring to FIG. 1, illustrated is an aerial navigation system 100 in accordance with an embodiment of the present disclosure. The aerial navigation system 100 includes an aerial robotic arrangement 101. The aerial robotic arrangement has a plurality of upright members 103, each of which is supported on a substantially horizontal surface. Such substantially horizontal surface in a preferred embodiment is a ground surface G (hereinafter referred to as ‘the ground’ and denoted using identical reference ‘G’). To provide adequate support for structural integrity, at least a portion of the upright members 103 may be driven into the ground G. Examples of structures that can be used to form the upright member 103 may include, but is not limited to, a wall, a pillar, a pole, or a post. Each of the upright members 103 may generally be of same height and be driven into the ground G such that a top-most end of each of the upright member 103 is disposed at a same height h from the ground G. An electric motor 104 is mounted on each upright member 103. Each electric motor 104 is positioned on the respective upright member 103 such that each electric motor 104 is positioned at a substantially same height from the ground G. In one configuration, each motor 104 is positioned at the top-most end or on top of respective one of each of the upright members 103 (i.e., at height ‘h’). Each electric motor 104 may be provided with a rotor (not shown). In an example, each of the electric motors 104 may be implemented as an electric stepper motor, or specifically a direct current (DC) stepper motor; with the electric motors 104 sometimes referred to as ‘the electric stepper motor’ or ‘the stepper motor’ without any limitations.

As illustrated in FIG. 1, a carrier device 105 is coupled to the electric motors 104 using a set of wires 102 (hereinafter, sometimes, individually referred to as ‘the horizontal wire’ and denoted using identical reference numeral ‘102’). In one configuration, the rotor from each electric motor 104 is coupled with a first end of a corresponding horizontal wire 102 that is arranged so that the rest of the corresponding horizontal wire 102 is at least partly wrapped around the rotor. Moreover, a second end of each horizontal wire 102 from the set of horizontal wires 102 is coupled with the carrier device 105.

The carrier device 105 itself houses at least one electric motor 109. The electric motor 109 includes a rotor (not shown). In an example, the electric motor 109 associated with the carrier device 105 may also be implemented as a DC stepper motor. The rotor of the electric motor 109 is coupled with a first end of a wire 107 (hereinafter, sometimes, referred to as ‘the vertical wire’ and denoted using identical reference numeral ‘107’). The vertical wire 107 is arranged so that at least a portion of the vertical wire 107 is wound around the rotor of the electric motor 109 associated with the carrier device 105.

An aerial robotic device 106 (hereinafter also referred to as ‘the robotic device’ and denoted using identical reference numeral ‘106’) is suspended from a second end of the vertical wire 107. The robotic device 106 is adapted to move vertically relative to the carrier device 105 through the activation of the electric motor 109 in the carrier device 105 to cause the vertical wire 107 to be further wound or unwound from the rotor of the electric motor 109, thereby shortening or lengthening the vertical wire 107, and thereby the distance between the carrier device 105 and the robotic device 106.

It may be contemplated that, alternatively, the robotic device 106 may be provided with an electric motor (not shown) with at least a portion of the vertical wire 107 wound around a rotor of such electric motor, such that robotic device 106 is adapted to move vertically relative to the carrier device 105 through the activation of such electric motor in the robotic device 106 to cause the vertical wire 107 to be further wound or unwound from the rotor of such electric motor.

In view of the above, for clarity, the electric motors 104 mounted on the upright members 103 will be referred to henceforth as horizontal movement motors (denoted using identical reference numeral ‘104’). Similarly, the electric motor(s) 109 in the carrier device 105 will be referred to henceforth as vertical movement motor(s) (denoted using identical reference numeral ‘109’).

The carrier device 105 is adapted to operably move within a bounded horizontal plane 112 defined between the horizontal movement motors 104. This movement is achieved through the activation of the horizontal movement motors 104 to cause the horizontal wire 102 coupled to each horizontal movement motor 104 to be further wound or unwound from the rotor thereof, and thereby shortening or lengthening each such horizontal wire 102. Further, the horizontal plane 112 defined by the horizontal wires 102, the ground G and the plurality of upright members 103 collectively define a volume within which the robotic device 106 resides. For clarity, this volume will be referred to henceforth as an aerial movement volume 110. When the aerial movement volume 110 is defined by the relative arrangement of the horizontal plane 112, the ground G and the plurality of upright members 103, the location of the robotic device 106 within the aerial movement volume 110 is defined by the following parameters:
the coordinates of the carrier device 105 in the bounded horizontal plane 112 defined by the elevated anchor points 104; and
the distance between the carrier device 105 and the robotic device 106, the said distance representing the vertical penetration of the robotic device 106 into the aerial movement volume 110.

As would be understood, herein, the co-ordinates of the carrier device 105 in the horizontal plane 112 is determined by the lengths of the individual horizontal wires 102 coupling the carrier device 105 to each of the respective horizontal movement motors 104. Similarly, the distance between the carrier device 105 and the robotic device 106 is denoted by the unwound length of the vertical wire 107 connecting the robotic device 106 to the carrier device 105.

In an embodiment of the present disclosure, the aerial robotic arrangement 101 is controlled by a navigation control unit 114 (hereinafter also referred to as ‘the control unit’ and denoted using identical reference numeral ‘114’). The navigation control unit 114 may be implemented in hardware, firmware or software, or some combination of at least two of the same. It should be noted that the functionality associated with the navigation control unit 114 may be centralized or distributed, whether locally or remotely. The navigation control unit 114 may be a multi-core processor, a single core processor, or a combination of one or more multi-core processors and one or more single core processors. For example, the one or more processors may be embodied as one or more of various processing devices, such as a coprocessor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. Further, the memory may include one or more non-transitory computer-readable storage media that can be read or accessed by other components in the device. The memory may be any computer-readable storage media, including volatile and/or non-volatile storage components, such as optical, magnetic, organic or other memory or disc storage, which can be integrated in whole or in part with the device. In some examples, the memory may be implemented using a single physical device (e.g., optical, magnetic, organic or other memory or disc storage unit), while in other embodiments, the memory may be implemented using two or more physical devices without any limitations. The navigation control unit 114 may be implemented as a combination of hardware and software, for example, programmable instructions that are consistent with the implementation of one or more functionalities disclosed herein.

In embodiments of the present disclosure, the navigation control unit 114 may include a real-time synchronization interface 118 configured to synchronize the operations of the horizontal movement motors 104 and the vertical movement motors 109 to permit the robotic device 106 to be moved from its current location to a target location within the aerial movement volume 110, without the necessity of human intervention. For sake of simplicity, referring to FIG. 1, the carrier device 105 is shown adapted to move within the bounded horizontal plane 112. The movement of the carrier device 105 is achieved by varying the length i.e., through the lengthening or shortening of at least two horizontal wires 102 from the set of horizontal wires 102 that connect the carrier device 105 to the electric motors 104. Herein, the shared real-time synchronization interface 118 ensures simultaneous yet independent control and operation of the respective horizontal movement motors 104 by maintaining the set of horizontal wires 102 moveably connecting each electric motor 104 to the carrier device 105 taut by mutually optimized speeds, directions and numbers of rotation executed by corresponding ones of the horizontal movement motors 104. However, it is hereby contemplated that in alternative embodiments of the present disclosure, the set of horizontal wires 102 may not be taut, rather, the carrier device 105 may be partially suspended in relation to the horizontal plane 112 using pre-computed slack willfully, or deliberately, imparted to one or more of the horizontal wires 102, as computed by the navigation control unit 114 depending upon specific requirements of an application. In an example, the real-time synchronization interface 118 may be implemented, for example, with use of an EtherCAT microchip as known in the art.

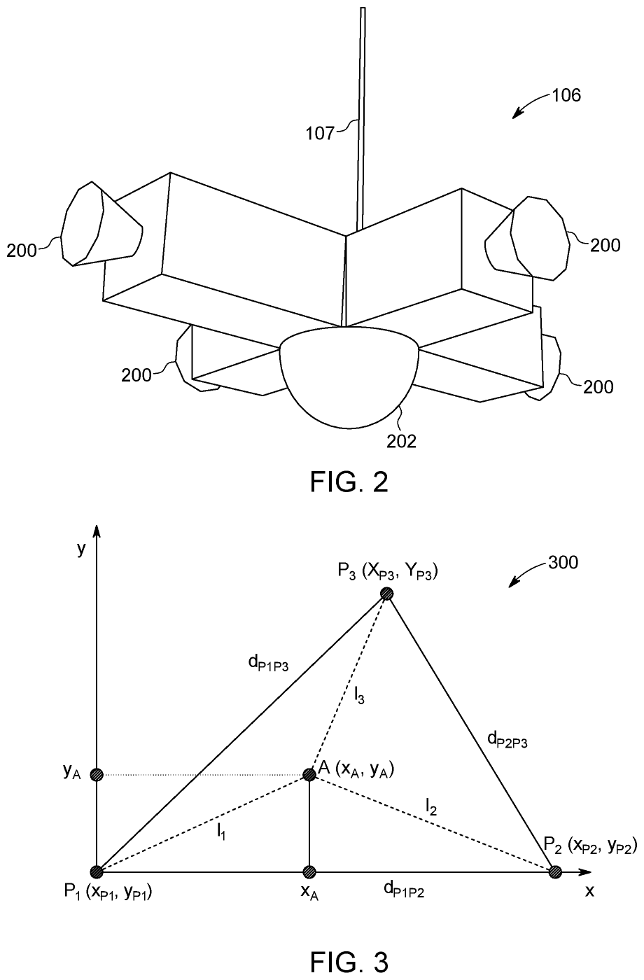

Referring to FIG. 2, illustrated is a detailed view of the robotic device 106, in accordance with an embodiment of the present disclosure. As shown, the robotic device 106 includes one or more depth detecting sensors 200. The one or more depth detecting sensors 200 are configured to capture image frames of a vicinity of the robotic device 106 within a field of view thereof. Herein, the “vicinity” may refer to surrounding volume to the robotic device 106 within the field of view of the depth detecting sensors 200. In a configuration, the robotic device 106 includes a plurality of depth detecting sensors 200. In an example, the depth detecting sensors 200 may be implemented as RGB-D cameras (hereinafter individually referred to as ‘the RGB-D camera’ and denoted using identical reference numeral ‘200’). Herein, the RGB-D cameras 200 are devices configured to capture video footage comprising a plurality of video frames (sometimes referred to herein as “images” without any limitations) with depth perception. In particular, the robotic device 106 may include an arrangement of several RGB-D cameras 200 mounted on an exterior surface thereof and aligned in a horizontal plane in a substantially circular pattern. For clarity, these RGB-D cameras 200 will be referred to henceforth as ‘radial RGB-D cameras’. In an embodiment, as shown in FIG. 2, the radial RGB-D cameras 200 may be mounted on a rig which is mounted in a surrounding arrangement around the robotic device 106. The radial RGB-D cameras 200 are arranged so that their combined fields of view provide 360 degree coverage of the area around or vicinity of the robotic device 106. Generally, the number N of radial RGB-D cameras 200 should exceed

$$\vert \frac{{360}^{o}}{FoVh} \vert ,$$

where Fo Vh represents the horizontal opening of Field of View of the radial RGB-D cameras 200.

Depth maps are generated based on the video footage. These depth maps are generated for example by stitching together of video footage from each of the depth detection sensors 200. To support the stitching together of video footage from each of the radial RGB-D cameras 200 (as will be discussed later in detail), the radial RGB-D cameras 200 should be arranged so that the Fields of View of adjacent radial RGB-D cameras 200 at least partly overlap. Furthermore, to ensure continuity at the horizontal edges of their Fields of View, the radial RGB-D cameras 200 must be calibrated before use (for example, by employing the technique described in A P. -Yus, E. F.-Moral, G. L. -Nicolas, J. Guerrero, P. Rives. IEEE Robotics and Automation Letters, 2018, 3(1), pp. 273-280, incorporated herein by reference). In this method one of the radial RGB-D cameras 200 is deemed to be the reference and the calibration parameters are then estimated for the other N−1 radial RGB-D cameras 200 relative to this reference. The calibration parameters define two transformations as rotation and translation that allow alignment of the depth images/video frames.

Also, as shown in FIG. 2, the robotic device 106 includes a further depth detecting sensor 202. In the present example, the further depth detecting sensor 202 may also be implemented as RGB-D camera (denoted using identical reference numeral ‘202’). The further RGB-D camera 202 is mounted on the robotic device 106. The further RGB-D camera 202 is arranged on the bottom of the robotic device. It will be appreciated that the “bottom” when in use, is the portion of the robotic device facing in a downwards direction towards the first horizontal surface or ground. In a downwards facing orientation the said further RGB-D camera 202 captures the area beneath the robotic device 106. Herein, this further RGB-D camera 202 will be referred to henceforth as the bottom RGB-D camera 202. For the purposes of the present disclosure, the bottom RGB-D camera 202 is used to detect potential collisions with obstacles during vertical movements of the robotic device 106 (relative to the carrier device 105), as will be discussed later in more detail.

As would be contemplated by a person skilled in the art that together, the radial RGB-D cameras 200 and the bottom RGB-D camera 202 provide a total of N+1 cameras installed on the robotic device 106. The resulting collective Fields of View of the radial RGB-D cameras 200 and the bottom RGB-D camera 202 is substantially hemispherical in shape with a downwards orientation. This is an optimal configuration for the detection of potential obstacles in the vicinity of the robotic device 106 since the likelihood of there being obstacles being located above the robotic device 106 is slim, because such obstacles would in all likelihood have already intersected with the carrier device 105 and/or the wires 102, 107.

It may be appreciated that the said RGB-D cameras 200, 202 generally acts as depth-detecting sensors that combines RGB color information with per-pixel depth information. In other embodiments, the depth detecting sensors 200, 202 may include radar sensors without departing from the scope of the present disclosure. The skilled person will understand that the above-mentioned examples of depth-detecting sensors are provided for illustration purposes only. In particular, the skilled person will understand that the preferred embodiment is not limited to the use of these above-mentioned depth-detecting sensors. Instead, the preferred embodiment is operable with any sensor capable of detecting the distance between itself and another object detected within the range of the sensor.

### Relative Co-ordinate System for the Aerial Robotic Arrangement 101

As discussed in reference to FIG. 1, the horizontal wires 102, the upright members 103 and the ground G effectively define a bounded prismatic volume, referred to as the aerial movement volume 110, within which the robotic device 106 resides and can move. The aerial movement volume 110 forms the basis of a co-ordinate system for navigating the robotic device 106. The following discussion of the relative co-ordinate system starts with a description of the two dimensional carrier device reference system (2D-CDRS) which describes the location and movements of the carrier device 105 in a substantially horizontal plane. By considering the height h of the horizontal movement motors 104 from the ground G and including the substantially vertical movements of the robotic device 106 relative to the carrier device 105, the following discussion will expand the discussion of the two dimensional carrier device reference system to express a complete three dimensional navigation reference system for the entire aerial movement volume 110.

### Two-Dimensional Carrier Device Reference System (2D-CDRS)

Referring to FIG. 3 together with FIG. 1, a two-dimensional carrier device reference system (2D-CDRS) 300 is formed in the horizontal plane 112 defined by the horizontal movement motors 104. The 2D-CDRS 300 is a triangular 2D projection of the aerial movement volume 110 onto the horizontal plane 112 formed by the three horizontal movement motors 104. The 2D-CDRS 300 comprises three vertices P1, P2 and P3, wherein:
the first vertex P1 corresponds to the intersection of the horizontal plane 112 with a first one of the horizontal movement motors 104 mounted on a first one of the upright members 103;
the second vertex P2 corresponds to the intersection of the horizontal plane 112 with a second one of the horizontal movement motors 104 mounted on a second one of the upright members 103; and
the third vertex P3 corresponds to the intersection of the horizontal plane 112 with a third one of the horizontal movement motors 104 mounted on a third one of the upright members 103.

Herein, the position, within the 2D-CDRS 300, of each of P1, P2 and P3 is denoted by (x_{P1}, y_{P1}), (x_{P2}, y_{P2}) and (x_{P3}, y_{P3}), respectively. The first vertex P1 is defined to be the origin of the 2D-CDRS 300, in which x_{P1}=0 and y_{P1}=0. From this, it may also be inferred that y_{P2}=0. The remaining co-ordinates of the second and third vertices P2 and P3 are computed based on the known distances {d_{P1P2}, d_{P1P3}, d_{P2P3}} between the upright members 103. More specifically,

$$\begin{matrix}{x}_{P 2} = {d}_{P 1 P 2} & ( 1 ) \\ {x}_{{p}_{3}} = \frac{{d}_{P 1 P 3}^{2} + {d}_{P 1 P 2}^{2} - {d}_{P 2 P 3}^{2}}{2 {d}_{P 1 P 2}} & ( 2 ) \\ {y}_{{P}_{3}} = \sqrt{{d}_{P 1 P 3}^{2} - {x}_{P 3}^{2}} & ( 3 )\end{matrix}$$

### Three Dimensional Navigation Reference System (3D-NRS)

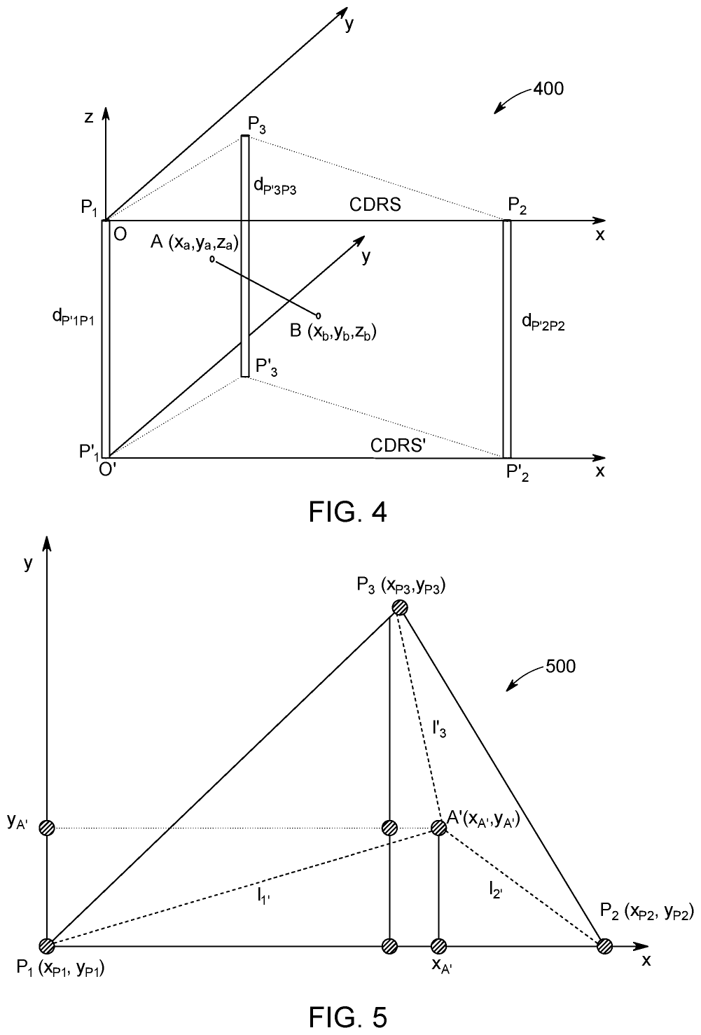

Referring to FIG. 4 together with FIG. 1, a first one of the upright members 103 establishes a base point P′ 1 located level with the ground G. A first horizontal movement motor 104 mounted on the first upright member 103 establishes an upper point P1 with an elevation of d_{P′1P1} from the ground G. A second one of the upright members 103 establishes a base point P′2 located level with the ground G. The second horizontal movement motor 104 mounted on the second upright member 103 establishes an upper point P2 with an elevation of d_{P′2P2} from the ground G. A third one of the upright members 103 establishes a base P3′ located level with the ground G. The third horizontal movement motor 104 mounted on the third upright member 103 establishes an upper point P3 with an elevation of d_{P′3P3} from the ground G. A three dimensional navigation reference system (3D-NRS) 400 for the robotic device 106 is formed in the volume defined by the points P1, P2, P3, P1′, P2′ and P3′.

A first horizontal plane CDRS′ is the plane defined by the vertices P′1, P′2 and P′3. A second horizontal plane CDRS is the plane defined by the vertices P1, P2 and P3. Because each electric motor 104 is mounted on the corresponding upright member 103 at the same height h above the ground G, therefore d_{P1P1}=d_{P′2P2}=d_{P3P3}=h. Thus, the second horizontal plane CDRS is disposed in parallel with the first horizontal plane CDRS′. Furthermore, the projection of the vertex P1 onto the first horizontal plane CDRS′ is the vertex P′1. Thus, it is straightforward to infer that the two dimensional projection of any three dimensional point located inside the volume defined by P1, P2, P3, P′1, P′2, P′3 (i.e., the aerial movement volume 110) will have the same x and y coordinates in both the CDRS and CDRS′ planes.

Thus, defining P′1 as the origin of the three dimensional navigation reference system; and knowing the distances {d_{P1P2}, d_{P1P3}, d_{P2P3}} between the electric motors 104; the x and y co-ordinates of the vertices P′1, P′2 and P′3 are defined as follows:

$$\begin{matrix}{x}_{P ′1} = 0 , {y}_{{P}^{′} 1} = 0 , {z}_{{P}^{′} 1} = 0 & ( 4 ) \\ {x}_{P ′2} = {d}_{P ′1 P ′2} , {y}_{{P}^{′} 2} = 0 , {z}_{{P}^{′} 2} = 0 & ( 5 )\end{matrix}$$

$${z}_{p {′}_{3}} = \frac{{d}_{P ′1 P ′3}^{2} + {d}_{P ′1 P ′2}^{2} - {d}_{P ′2 P + 3}^{2}}{2 {d}_{P ′1 P ′2}} , {y}_{P {′}_{3}} = \sqrt{{d}_{P ′1 P ′3}^{2} - {x}_{P ′3}^{2}} , {z}_{{P}^{′} 3} = 0 , \qquad ( 6 )$$

The x and y co-ordinates of the vertices P′1, P′2 and P′3 of the 3D-NRS 400 are the same as the P1, P2 and P3. Indeed, the P′1, P′2 and P′3 vertices differ from the P1, P2 and P3 vertices in the z coordinate only (z_{P1}32 z_{P2}=z_{P3}=d_{P′1P1}). Similarly, the distances between corresponding vertices in the first horizontal plane CDRS′ is the same as those in the second horizontal planes CDRS. For example, d_{P1P2}=d_{P′1P′2}.

The location of the robotic device 106 within the 3D-NRS 400 is defined by the following parameters:
(a) the coordinates of the carrier device 105 in the second horizontal plane CDRS; and
(b) the distance between the carrier device 105 and the robotic device 106, denoted by the unwound length of the wire 107 (representing the vertical penetration of the robotic device 106 into the aerial movement volume 110).

As shown in FIG. 3, the co-ordinates of the carrier device 105 in the second horizontal plane CDRS are determined by the lengths of the individual wires 102 coupling the carrier device 105 to each of the respective electric motors 104. More specifically, a first location of the carrier device 105 in the second horizontal plane CDRS is shown by a point A, whose co-ordinates are (x_{A}, y_{A}). This point A is connected to the vertices P1, P2 and P3 by line segments of length l₁, l₂ and l₃ respectively, where these lengths correspond with the lengths of the wires connecting the carrier device 105 to the electric motors 104. The lengths (l₁ and l₂) of the line segments connecting the point A to the vertices P1 and P2 can be expressed as follows:

l₁²=x_{A}²+y_{A}² (7)

l₂²=(x_{P2}−x_{A})²+y_{A}² (8)

Combining these two expressions, the co-ordinates (x_{A}, y_{A}) of the point A can be established as follows:

$$\begin{matrix}{l}_{1}^{2} - {l}_{2}^{2} = {x}_{A}^{2} - {( {x}_{P 2} - {x}_{A} )}^{2} & ( 9 ) \\ 2 {x}_{A} {x}_{P 2} = ( {l}_{1}^{2} - {l}_{2}^{2} ) + {x}_{P 2}^{2} & ( 10 ) \\ {x}_{A} = \frac{( {l}_{1}^{2} - {l}_{2}^{2} ) + {x}_{P 2}^{2}}{2 {x}_{P 2}} & ( 11 ) \\ {y}_{A} = \sqrt{{l}_{1}^{2} - {x}_{A}^{2}} & ( 12 )\end{matrix}$$

Referring to FIG. 5 together with FIG. 4 and FIG. 1, a projection 500 of the 3D-NRS 400 into the second horizontal plane CDRS of the 2D-CDRS 300 is illustrated. As shown, the projection of a second location in the 3D-NRS 400 into the second horizontal plane CDRS of the 2D-CDRS 300, is a point A′ with coordinates (x_{A′}, y_{A′}). In an analogous fashion to the above derivation of the coordinates of the first location A, the coordinates of the second location A′ can also be defined in terms of lengths l′₁, l′₂, l′₃ of the individual wires 102 that would be needed to position the carrier device 105 at that second location A′. Specifically, l′₁, l′₂, l′₃ are the lengths of the line segments connecting the point A′ to the vertices P1, P2 and P3, and are expressed as follows:

$$\begin{matrix}{l}_{1}^{′} = \sqrt{{x}_{A ′}^{2} + {y}_{A ′}^{2}} & ( 13 ) \\ {l}_{2}^{′} = \sqrt{{( {x}_{{P}_{2}} - {x}_{A ′} )}^{2} + {y}_{A ′}^{2}} & ( 14 ) \\ {l}_{3}^{′} = \sqrt{{( {x}_{A ′} - {x}_{{P}_{3}} )}^{2} + {( {y}_{{P}_{3}} - {y}_{A ′} )}^{2}} & ( 15 )\end{matrix}$$

Referring to FIG. 1, to move the carrier device 105 from a first location to a second location, each horizontal movement motor 104 is provided with a local computing device (not shown). Each local computing device implements a rudimentary real-time operating system with low-level device drivers to control the corresponding electric motor 104. Synchronization of the movements of all the electric motors 104 is achieved via their connection through the real-time synchronization interface 118 to allow the carrier device 105 to be moved at a desired speed ξ (e.g., ξ=0.1 m/s). The desired speed is a balance between the imperatives of reducing travel time and constraints imposed by the physical limitations of the construction to ensure safe movement.

To move the carrier device 105 from the first location A to the second location A′, each horizontal movement motor i [with i ε E {1,2,3}] is controlled to deliver the following movement parameters:
Number of rotation steps (nrotᵢ) needed for the electric stepper motor ‘i’ to wind/unwind its wire 102 by a required length (where the electric stepper motor acts as a spool with its axle arranged so that it winds/unwinds k cm of wire (e.g., k=0.01 m) with each complete rotation).

$${nrot}_{i} = \frac{\vert {l}_{i} - {l}_{i}^{′} \vert}{k} \qquad ( 16 )$$

Direction of rotation (dirᵢ): as in use, a stepper motor ‘i’ winds or unwinds its wire 102 by the length (l′ᵢ) needed to move the carrier device 105 from its current location to the desired end-point as detailed above, the rotation direction needed for such winding/unwinding operation is described as +1 for clockwise rotation and −1 for anticlockwise rotation.

dirᵢ=sign(lᵢ−l′ᵢ) (17)
Speed of rotation θᵢ: to move the carrier device 105 from the first location to the second location in a certain amount of time, all the stepper motors must wind/unwind their respective lengths of wire within the same amount of time. Thus, each stepper motor must be capable of operating at different speeds from the others. More specifically, to move the carrier device 105 at a predefined speed of ξ m/s (e.g., ξ=0.1 m/s), the rotational speed θᵢ of each stepper motor (expressed as the number of rotations performed per second) is given by the following equations:

$$\begin{matrix}{θ}_{i} = \frac{{nrot}_{i}}{{t}_{nav}} & ( 18 ) \\ where {t}_{nav} = \frac{\sqrt{{( {x}_{{A}^{′}} - {x}_{A} )}^{2} + {( {y}_{{A}^{′}} - {y}_{A} )}^{2}}}{ξ} & ( 19 )\end{matrix}$$

Expanding the system's movements from the second horizontal plane CDRS to the three dimensional navigation reference system (3D-NRS 400), the robotic device 106 is lowered/raised from an altitude z_{A} of the first location A to an altitude z_{A′} of the second location A′. This is achieved using the vertical movement motor 109 which controls the wire that links the carrier device 105 and the robotic device 106. The movement parameters (nrot_{ARD}, dir_{ARD}, and θ_{ARD}) for this vertical movement motor 109 are determined using the equations below.

$$\begin{matrix}{nrot}_{ARD} = \frac{\vert {z}_{A} - {z}_{A ′} \vert}{k} & ( 20 ) \\ {dir}_{ARD} = sign ( {z}_{A} - {z}_{A ′} ) & ( 21 ) \\ {θ}_{ARD} = \frac{{nrot}_{ARD}}{{t}_{hi \_ lo}} \\ where : & ( 22 ) \\ {t}_{hi \_ lo} = \frac{\vert {z}_{A} - {z}_{A ′} \vert}{ξ} & ( 23 )\end{matrix}$$

Using the above equations, movement parameters (nrotᵢ, dirᵢ and θᵢ) and (nrot_{ARD}, dir_{ARD}, θ_{ARD}) for each horizontal movement motor 104 are calculated and communicated to a local computing device associated with the relevant electric motor 104. Each local computing device is provided with a buffer which stores the movement parameters. Each local computing device is synchronized through the real-time synchronization interface 118, to ensure simultaneous control and operation of the respective electric motor 104.

The above discussion assumes that the aerial movement volume 110 is empty of anything other than the wires 102, 107, the carrier device 105 and the robotic device 106. However, in real-life, the aerial movement volume 110 may contain several moving and unmoving items, all of which pose collision hazards for the robotic device 106. The purpose of the present disclosure is to devise a mechanism for moving the robotic device 106 from a first location to a second location in the aerial movement volume 110, along an optimal path which avoids collision with moving and unmoving intervening obstacles.

### Aerial Robotic Device Reference System (ARDRS)

Hereinbefore, a relative co-ordinate system for describing movements of the aerial robotic device 106 and the carrier device 105 was discussed. The relative co-ordinate system was defined with reference to the physical layout and infrastructure of the aerial navigation system 100, including the upright members 103, the electric motors 104 and the wires 102. Herein, the upright members 103, the electric motors 104 and the wires 102 has been referred to henceforth collectively as the Fixed Physical Infrastructure.

Further, as discussed, obstacles proximal to the aerial robotic device 106 are detected by the depth detecting sensors 200, 202 mounted thereon as it moves within the aerial movement volume 110. In other words, by being mounted on the aerial robotic device 106, the depth detecting sensors 200, 202 are effectively moving within the aerial movement volume 110 while undertaking proximal object detections. Indeed, all intensity values of the depth detecting sensors 200, 202 relate to a distance between the image plane and a corresponding object appearing in the RGB image, as captured thereby. Thus, to interpret the measurements made by the depth detecting sensors 200, 202, a further co-ordinate system is defined with reference to the aerial robotic device 106 itself (rather than the Fixed Physical Infrastructure) to describe the location of an obstacle relative to the aerial robotic device 106 as measured by a sensor mounted thereon. Herein for clarity, this further co-ordinate system will be referred to henceforth as the Aerial Robotic Device Reference System (ARDRS). That is, the aerial robotic device 106 itself defines a local reference system used to interpret the measurements of the depth detecting sensors 200, 202 mounted on the aerial robotic device 106.

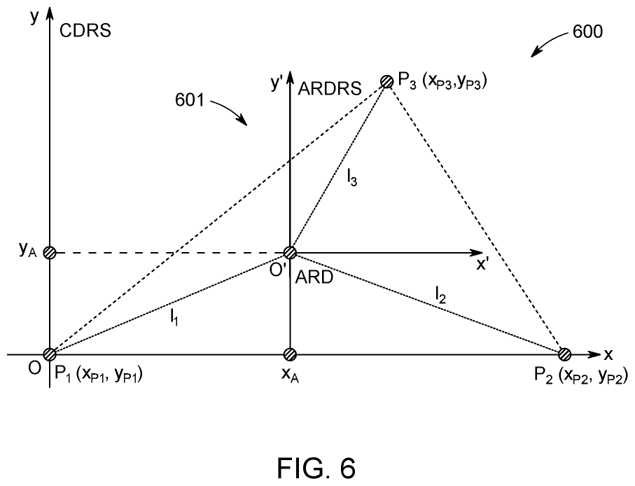

Referring to FIG. 6, a projection 600 showing translation between co-ordinates in the Aerial Robotic Device Reference System (ARDRS) 601 and co-ordinates in the CDRS of the 2D-CDRS 300 is illustrated. As shown, the local ARDRS 601 is defined as having its origin at the center of the aerial robotic device 106. As the aerial robotic device 106 does not rotate during navigation, the aerial robotic device 106 is considered to have a fixed spatial orientation. Thus, the ARDRS 601 is defined as having horizontal and vertical axes, O′x′ and O′y′ respectively, aligned in parallel with the corresponding horizontal and vertical axes Ox and Oy of the CDRS of the 2D-CDRS 300 as shown in FIG. 3. Similarly, the horizontal and vertical axes O′x′ and O′y′ respectively of the ARDRS 601 are arranged with the same orientation as the corresponding horizontal and vertical axes Ox and Oy respectively of the CDRS of the 2D-CDRS 300.

Following the above definition of the ARDRS 601, a transformation between coordinates defined in the ARDRS 601 and those in the CDRS of the 2D-CDRS 300 is expressed by a translation vector, T=[x_{A}, y_{A}, 1]^{T}, where x_{A} and y_{A} represents the coordinates of the aerial robotic device 106 in the CDRS at the instant of the transformation. Indeed, because of the above definition of the ARDRS 601, no rotation or scaling transformations are necessary on moving between the ARDRS 601 and the CDRS of the 2D-CDRS 300. Specifically, the rotation angle is 0 and the scaling factor is 1 on both sets of horizontal and vertical axes (O′x′ and O′y′; and Ox and Oy).

Further, the extension of the ARDRS 601 to the 3D-NRS 400 is performed using the procedure as described above, together with a 3D translation vector defined as [x_{A}, y_{A}, z_{A}, 1]^{T}, where z_{A} represents the altitude of aerial robotic device 106 in the 3D-NRS 400 at the instant of the transformation. That is, using the known location of the aerial robotic device 106 within the 3D-NRS 400, the measured location of the obstacle within the ARDRS 601 may be translated into a location within the 3D-NRS 400. This is utilized to create a global environment map (GEM) of the aerial movement volume 110, as will be discussed later in detail, which in turn may be used to compute a correspondence between the projections of obstacles (objects) detected in the aerial movement volume 110 and the pixels of the GEM.

It may be understood that the localization of depth points of the objects detected by the RGB-D cameras 200, 202 are first computed in the ARDRS 601 and then transformed to the 2D-CDRS 300 coordinates. This transformation is used by a global map unit of software components of the aerial navigation system 100, to map depth points generated by the bottom RGB-D camera 202 to global environment map pixels, as will be explained later. Using the intrinsic parameters of the RGB-D cameras 200, 202, the intensity values measured by the depth detecting sensor of each RGB-D camera 200, 202 are translated into a metric system as.

$$[ \begin{matrix}x \\ y \\ z \\ 1\end{matrix} ] = z [ \begin{matrix}1 / {f}_{x} & 0 & 0 & 0 \\ 0 & 1 / {f}_{y} & 0 & 0 \\ 0 & 0 & 1 & 0 \\ 0 & 0 & 0 & 1\end{matrix} ] [ \begin{matrix}u \\ v \\ 1 \\ 1 / z\end{matrix} ] \qquad ( 24 )$$

The intrinsic parameters fₓ and f_{y} represents the focal length on the horizontal and vertical Field of View, respectively, of the RGB-D cameras 200, 202, and the (u, v) coordinates represent the depth pixel coordinate in the image plane. The (x, y, z) spatial localization of the object is expressed here in terms of a local reference system of the RGB-D cameras 200, 202 having the z axes (the depth) disposed along the Field of View direction, and the x and y axes disposed on the camera image plane.

However, since each of the RGB-D cameras 200, 202 has a fixed position relative to the aerial robotic device 106 (because the RGB-D cameras 200, 202 are attached to the aerial robotic device 106) and considering the distance between the center of the aerial robotic device 106 and the RGB-D cameras 200, 202 to be negligible (since both have the same origin), transformation of the spatial coordinates of the RGB-D cameras 200, 202 into the ARDRS involves only two rotations that align the axes of the ARDRS with the axes of the local reference system of the RGB-D cameras 200, 202. The parameters of these rotations may be determined knowing the position and orientation of the RGB-D cameras 200, 202 attached to the aerial robotic device 106.

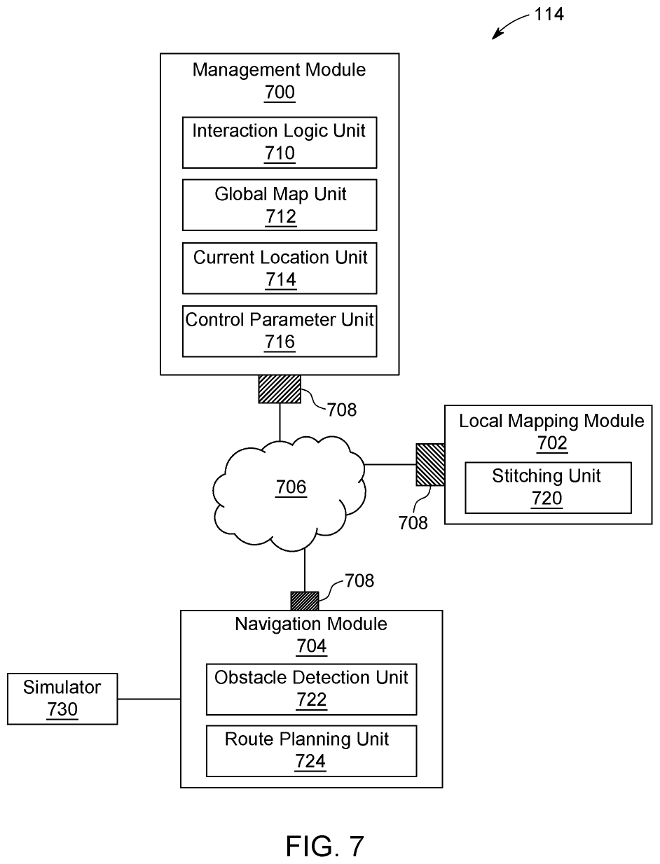

FIG. 7 illustrates a schematic of software components of the navigation control unit 114 of the aerial navigation system 100, in accordance with an embodiment of the present disclosure. As shown, the navigation control unit 114 comprises a management module 700; a local mapping module 702; and a navigation module 704, wherein each of the three modules is communicatively coupled to each other through a wireless or wired network 706. To implement this communicative coupling, each of the modules comprises a configured connection link 708 to the network 706.

Herein, the management module 700 comprises an interaction logic unit 710 adapted to receive data from the aerial robotic device 106, wherein the data relates to interactions with a customer. For example, the data may include statements from the customer (e.g., “I would like to make an order”) or menu selections, or payment instructions (e.g., from a payment card or other touchless payment mechanism), etc. It may be appreciated that for this purpose, in one or more examples, the aerial robotic device 106 may include a set of devices (not shown) adapted to permit interaction with a customer (not shown). The devices may include, for example, a display screen, a microphone, a speaker, a card reader, etc., without any limitations to the present disclosure.

The interaction logic unit 710 comprises one or more logical components (not shown) which use the received data to manage the interaction with the customer and thereby enable the aerial navigation system 100 to provide the required assistance to the customer. Herein, the required assistance may involve navigating the aerial robotic device 106 from a current location thereof to another location within the aerial movement volume 110 thereof, and such another location is defined as the target location for the aerial robotic device in the aerial movement volume 110. Herein, the target location is defined as a coordinate in the aerial movement volume 110, or specifically global environment map, as described in the proceeding paragraphs.

The management module 700 further comprises a global map unit 712, a current location unit 714 and a control parameter unit 716. Triggered by the management module 700, the global map unit 712 is adapted to store a 2D binary map of the entire aerial movement volume 110 and the items contained therein. Herein, this map will be referred to henceforth as a global environment map (GEM ε {0, 1}^{X}^{_{GEM}}^{×Y}^{_{GEM}}, e.g., in a possible embodiment x_{GEM}=1000 and y_{GEM}=250). The global environment map is generated by surveying the aerial movement volume 110 using the bottom RGB-D camera 202 of the aerial robotic device 106. Referring to FIG. 4, the global environment map details the locations of items in the aerial movement volume 110 by establishing a 2D projection thereof onto the first 2D horizontal plane CDRS′. In this way, the global environment map contains the projections onto CDRS′ of all the items detected in the aerial movement volume 110, as shown in FIG. 10.

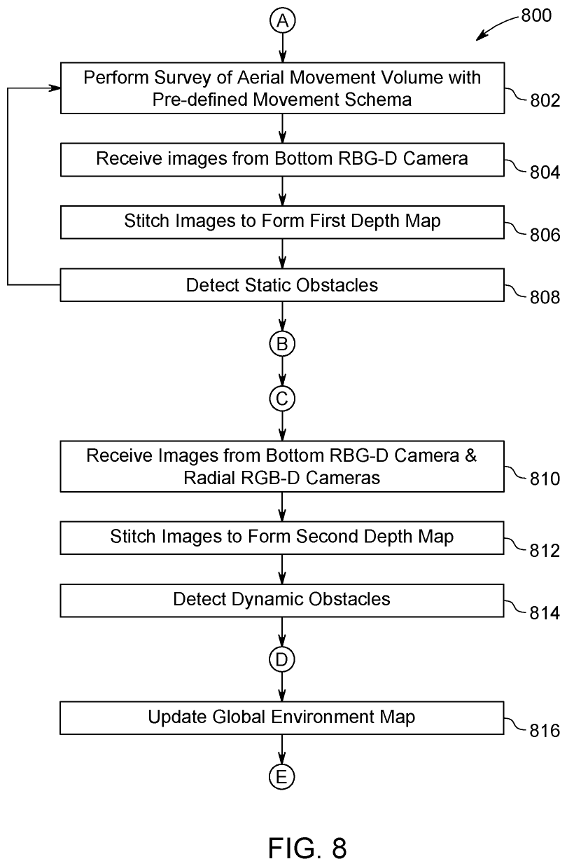

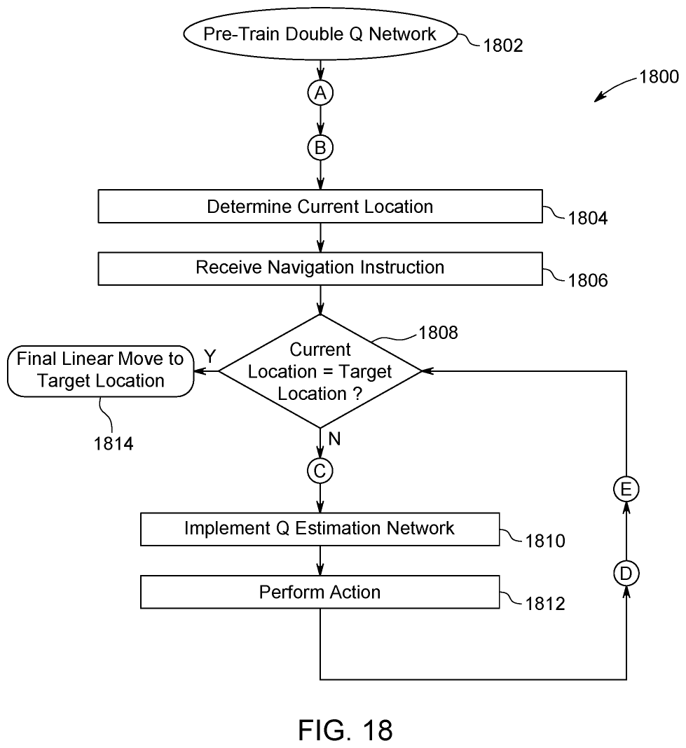

FIG. 8 illustrates a flowchart listing steps involved in a method 800 for generating the GEM of the aerial movement volume 110 and detecting static obstacles and dynamic obstacles therein. FIG. 18 illustrates a flowchart of a method 1800 of navigating the aerial robotic device 106 to a target location while avoiding intervening stationary and dynamic obstacles.

The method 800 of the present disclosure is implemented by using the navigation control unit 114 as described. The method 800 forms part of the method 1800, as will be discussed later. Accordingly, steps of the method 800 are interleaved with the steps of the method 1800, as will be discussed later. Thus, for simplicity and for ease of understanding, the following description of the method 800 will include brief references to associated steps in the method 1800. However, the associated steps in the method 1800 and their relationship with those in the method 800 will be described in more detail later.

Referring to FIG. 8 together with FIG. 18, the method 800 is preceded by a step from the method 1800 of pre-training 1802 a double Q network, as discussed later in detail in the description.

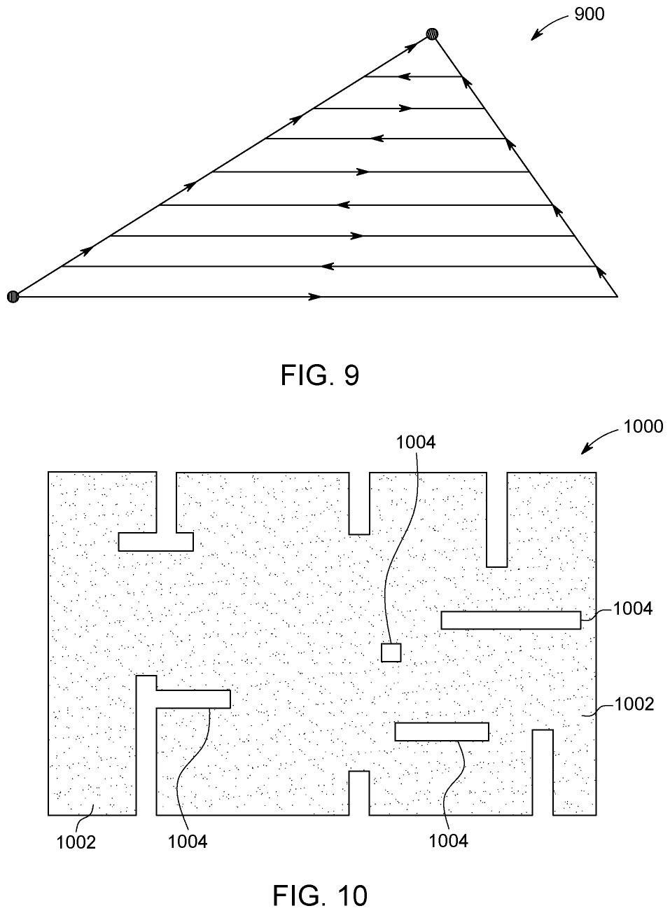

At step 802, the method 800 includes performing a survey of the aerial movement volume 110 by the aerial robotic device 106 in accordance with a pre-defined movement schema to generate a global environment map of the aerial movement volume 110. Herein, the term “pre-defined movement schema” may refer to a pre-programmed path to be followed by the aerial robotic device 106 for performing the survey of the aerial movement volume 110. FIG. 9 illustrates a depiction of a movement schema 900 to be followed by the aerial robotic device 106 for generating the global environment map 1000, in accordance with an embodiment of the present disclosure. As shown in FIG. 9, the aerial robotic device 106 performs a complete survey of the aerial movement volume 110 by following a looped zig-zag movement pattern at a minimum obstacle-free elevation, so that the bottom RGB-D camera 202 on the aerial robotic device 106 has a substantially unobscured view of the obstacles in the aerial movement volume 110. As used herein, the term “minimum obstacle-free elevation” may refer to an elevation (generally close to the height h) where a horizontal plane (i.e., a plane parallel to the ground G) could be ensured to be free of any obstacles. Herein, the first horizontal plane CDRS′ (as shown in FIG. 4) is divided into a plurality of looped movement paths arranged in parallel and progressing from the widest to the narrowest region of the first horizontal plane CDRS+. The distance between successive looped patrol paths is parametrized by p, the pace. The value of p is chosen so that it does not exceed the aperture of the depth detecting sensor of the bottom RGB-D camera 202 of the aerial robotic device 106. In this way, there are no gaps between the areas surveyed by successive looped patrol paths in the movement schema 900.

Returning to FIG. 8 together with FIG. 18, while performing the survey of the aerial movement volume 110 (as per step 802), the method 800 comprises a further step 804 of receiving images/video frames of dense depth captured by the bottom RGB-D camera 202. An image of dense depth is an image that contains information relating to the distance of the surfaces of objects in a viewed scene from a defined viewpoint. The method 800 comprises a next step 806 of stitching the images/video frames captured by the bottom RGB-D camera 202 to generate a first depth map. To this end, and referring to FIG. 7, the global map unit 712 employs a stitching algorithm (for example, as described in R. Szeliski, Foundations and Trends in Computer Graphics and Vision 2(1) 1-104, 2006, incorporated herein by reference) to the captured images/video frames, to construct a first depth map of objects in the aerial movement volume 110 and their distance from the bottom RGB-D camera 202 transformed into the 3D-NRS 400 coordinates as explained in the preceding paragraphs.

Returning to FIG. 8 together with FIG. 18, the method 800 comprises a next step 808 of detecting static obstacles in the aerial movement volume 110 based on an analysis of the first depth map. To this end, the global map unit 712 employs a segmentation algorithm to detect zones in the first depth map whose elevation exceeds a pre-defined threshold θ (e.g., θ=0.5 m). Herein, the “segmentation algorithm” partitions an image into sets of pixels or regions, such that the sets of pixels may represent objects in the image that are of interest for a specific application. Further, the “threshold” helps to classify the pixels falling below or above that as an object (obstacle in present examples). A skilled person will acknowledge that this value of the threshold is provided for illustration purposes only. In particular, the skilled person will acknowledge that the aerial navigation system of the present embodiment is not limited to the use of this value for the threshold. On the contrary, the aerial navigation system of the present embodiment is operable with any value of the threshold which is sufficient permit detection and avoidance of an object at a minimal elevation above the ground while addressing potential noise in the depth measurements of the bottom RGB-D camera 202. It may be appreciated that, in some examples, the threshold may be defined by implementing trial and error technique as known in the art.

Herein, for clarity, these detected zones will be referred to henceforth as elevated zones; and a location within an elevated zone will be referred to henceforth as an elevated location. Similarly, zones in the first depth map whose elevation is less than the pre-defined threshold θ will be referred to henceforth as flat zones; and a location within a flat zone will be referred to henceforth as a flat location.

The elevated zones indicate the presence of potential obstacles to the movement of the aerial robotic device 106. The global map unit 712 employs a Hough transform (for example, as described in R. O. Duda, and P. E. Hart, Comm. ACM, 1972 (15) pp. 12-15; and U.S. Pat. No. 3,069,654, incorporated herein by reference) to the borders of the elevated zones to enable the corners thereof to be identified. The first depth map and the detection of elevated zones therein form the global environment map 1000 as described in reference to FIG. 10.

Referring to FIG. 10, a depiction of an exemplary global environment map 1000 is illustrated. Herein, the global environment map 1000 is a binary-valued two dimensional map of the aerial movement volume 110. As shown, shaded pixels (as generally represented by reference numeral 1002) of the global environment map 1000, have values equal to 0 and represent flat zones. Similarly, white pixels (as generally represented by reference numeral 1004) of the global environment map 1000, have a value of 1 and represent elevated zones thereby showing objects detected in the aerial movement volume 110.

Bearing in mind the time taken by the aerial robotic device 106 to follow the looped zig-zag movement pattern, objects detected between successive looped patrol paths may be considered to be substantially stationary. Thus, for brevity such objects, as represented by the elevated zones in the global environment map 1000, will be referred to henceforth as static obstacles. The static obstacle(s) in the aerial movement volume 110 may be detected using the depth information of objects detected between successive looped patrol paths, as would be contemplated by a person skilled in the art and thus not explained in any more detail for the brevity of the present disclosure.

To adapt to environmental changes, the above steps may be repeated periodically (or on demand) to refresh or otherwise update the global environment map 1000. The frequency of such repeated operations is application dependent. Returning to FIG. 8 together with FIG. 18, the step 808 of detecting static obstacles in the aerial movement volume 110 from the method 800 is followed by the steps 1804, 1806 and 1808 from the method 1800, i.e., the step 1804 of determining the current location of the aerial robotic device 106; the step 1806 of receiving navigation instructions to move the aerial robotic device 106 to a target location; and the step 1808 of checking whether the current location of the aerial robotic device 106 substantially matches the target location.

Referring back to FIG. 7, the current location unit 714 is adapted to store a current location of the aerial robotic device 106, wherein the location is described using the three dimensional navigation reference system (3D-NRS 400) for the aerial robotic device 106. Further, the control parameter unit 716 is adapted to calculate the movement parameters (nrotᵢ, dirᵢ and θᵢ) and (nrot_{ARD}, dir_{ARD}, θ_{ARD}) for each stepper motor 104 (and also stepper motor 109) in accordance with a navigation route calculated by the navigation module 704, as will be described in the proceeding paragraphs.

It may be appreciated that since the global environment maps 1000 established by the global map unit 712 are only refreshed periodically, new items may enter the aerial movement volume 110 during the time between refreshments of the global environment map 1000. These moving items pose collision hazards for the aerial robotic device 106. For the sake of brevity, these items will be referred to henceforth as dynamic obstacles.

Returning to FIG. 8 together with FIG. 18, if at step 1808 of the method 1800, the current location of the aerial robotic device 106 does not substantially match the target location, the method 800 comprises a next step 810 of receiving video frames from the radial RGB-D cameras 200 and the bottom RGB-D camera 202. To this end, and referring to FIG. 7, in embodiments of the present disclosure, the local mapping module 702 is adapted to receive video frames from the radial RGB-D cameras 200 and the bottom RGB-D camera 202 mounted on the aerial robotic device 106 as it moves about the aerial movement volume 110. These video frames comprise images/video frames of dense depth and may be analyzed (as discussed) to provide information regarding the presence of items in the vicinity of the aerial robotic device 106 in the aerial movement volume 110 at any moment in time. Thus, these video frames are particularly suitable for the detection of nearby dynamic obstacles.

At step 812, the method 800 includes a step 812 of stitching the images/video frames captured by the radial RGB-D cameras 200 and further stitching them with images/video frames captured by the bottom RGB-D camera 202, to generate a second depth map. The second depth map details the presence or absence of objects within a pre-defined distance of the aerial robotic device 106, wherein the pre-defined distance is determined by the detection ranges of the depth detecting sensors 200, 202. Accordingly, it will be understood that the locations of the said objects are established with reference to a current location of the aerial robotic device 106, which is represented in turn by a set of co-ordinates in the global environment map 1000.

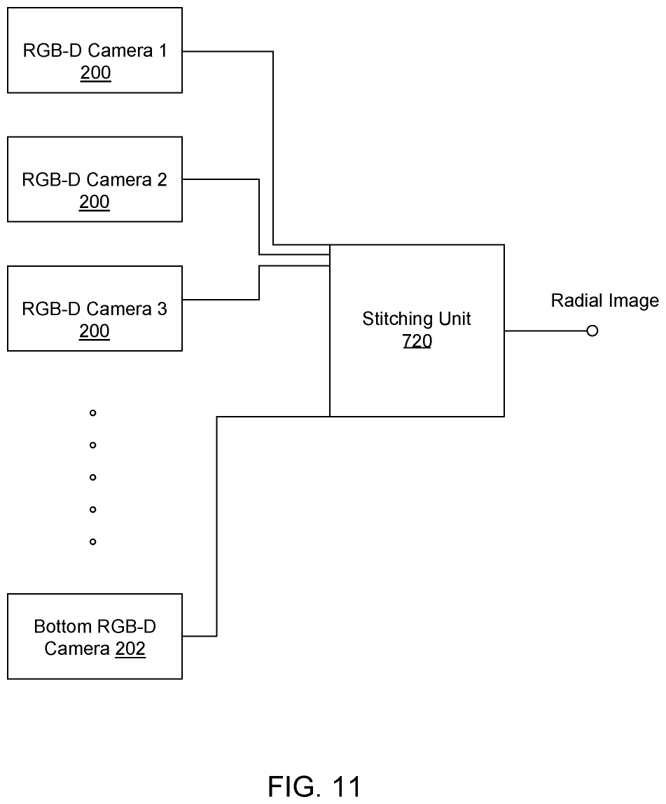

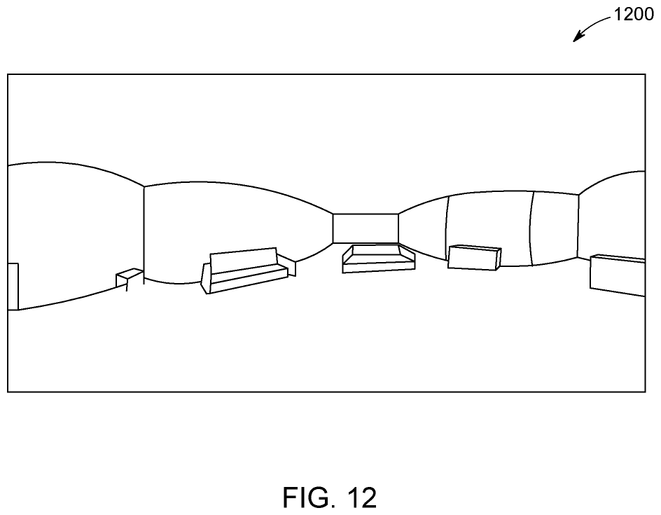

Referring to FIG. 11, a stitching unit 720, as part of the local mapping module 702 (as shown in FIG. 7), is adapted to use a stitching algorithm (for example, as described in Szeliski R. (2006) Image Alignment and Stitching. In: Paragios N., Chen Y., Faugeras O. (eds) Handbook of Mathematical Models in Computer Vision. Springer, Boston, MA, incorporated herein by reference) to stitch together the N depth images/video frames from the radial RGB-D cameras 200. To ensure consistency, the order in which the images/video frames from the radial RGB-D cameras 200 are stitched together is pre-configured. Herein, the stitched dense images/video frames from the radial RGB-D cameras 200 will be referred to henceforth as stitched radial images/video frames. In a corresponding fashion, the depth images/video frames from the bottom RGB-D camera 202 mounted on the aerial robotic device 106 will be referred to henceforth as bottom images/video frames. The stitched radial images/video frames are rescaled as are the bottom images/video frames. The resulting rescaled stitched radial images/video frames and rescaled bottom images/video frames are communicated in real time (at a frequency of δ samples/sec., e.g., δ=10) to the navigation module 704. FIG. 12 shows an example of a resulting generated second depth map (as represented by a reference numeral 1200) detailing the presence or absence of objects within the pre-defined distance of the aerial robotic device 106; wherein the locations of the said objects are established with reference to the current location of the aerial robotic device 106, which is represented in turn by a set of co-ordinates in the global environment map 1000.

In some embodiments, the method 800 further comprises re-scaling the generated second depth map 1200 to correspond to the generated global environment map 1000 of the aerial movement volume 110. For this purpose, the navigation module 704 is adapted to receive:
(a) The global environment map—GEM ε {0, 1}^{X}^{_{GEM}}^{×Y}^{_{GEM}}, from the global map unit 712. The navigation module 704 performs a rescaling operation to obtain the rescaled global environment map with dimensions X_{RGEM}×Y_{RGEM}. In a possible embodiment X_{RGEM}=200 and Y_{RGEM}=50. As discussed above, each pixel of the global environment map can have one of only two values. Specifically, a pixel in the global environment map may have a value of 1 which denotes an unoccupied corresponding point in the aerial movement volume 110. Alternatively, a pixel in the global environment map may have a value of 0 which denotes that the corresponding point in the aerial movement volume 110 is occupied by an object.
(b) The stitched radial image— RAD ε [symbol] ^{X}^{_{RAD}}^{×Y}^{_{RAD}}, from the local mapping module 702. Referring to FIG. 12, a stitched radial image is a monochrome map of depths detected by the radial RGB-D cameras 200. Specifically, each pixel in the stitched radial image represents the distance from the aerial robotic device 106 of a detection in a corresponding region. Each pixel in the stitched radial image may have a value of between 0 and 255. A pixel with a value of 0 denotes the detection in a corresponding region around the aerial robotic device 106 of something touching the aerial robotic device 106 (i.e., at a zero distance from the aerial robotic device 106). By contrast, a pixel with a value of 255 denotes the absence of anything detected around the aerial robotic device 106 within the detection range of the radial RGB-D camera 200. The navigation module 704 may perform a rescaling operation on the stitched radial image to obtain an X_{RRAD}×Y_{RRAD} image. In one possible embodiment, X_{RRAD}=200 and Y_{RRAD}=50.
(c) The bottom image—BTM ε [symbol] ^{X}^{_{BTM}}^{×Y}^{_{BTM}}, from the local mapping module 702. A bottom image is a monochrome map of depths detected by the bottom RGB-D camera 202. Specifically, each pixel in the bottom image represents the distance from the aerial robotic device 106 of a detection in a corresponding region. Each pixel in the bottom image may have a value of between 0 and 255. A pixel with a value of 0 denotes the detection in a corresponding region beneath the aerial robotic device 106 of something touching the aerial robotic device 106 (i.e., at a zero distance from the aerial robotic device 106). By contrast, a pixel with a value of 255 denotes the absence of anything detected beneath the aerial robotic device 106 within the detection range of the bottom RGB-D camera 202. The navigation module 704 may perform a rescaling operation on the bottom image to obtain an X_{RBTM}×Y_{RBTM} image. In one possible embodiment, X_{RBTM}=50 and Y_{RBTM}=50.
(d) the current location of the aerial robotic device 106, from the current location unit 714, expressed using the three dimensional navigation reference system (3D-NRS 400) and henceforth known as a current location; and
(e) the co-ordinates of a location to which it is desired for the aerial robotic device 106 to be navigated, expressed using the three dimensional navigation reference system (3D-NRS 400) and henceforth known as a target location.

To provide worst case maps for collision-free navigation, all rescaling operations are implemented via min-pool operations.

At step 814, the method 800 includes detecting one or more dynamic obstacles in the vicinity of the aerial robotic device 106 based on an analysis of the second depth map 1200 generated in the step 812. To this end, the navigation module 704 comprises an obstacle detection unit 722. The obstacle detection unit 722 is adapted to detect the presence of obstacles proximal (in vicinity) to aerial robotic device 106. Herein, the vicinity is a location within a pre-defined distance of the aerial robotic device 106, wherein the distance is determined by the detection range of the radial RGB-D cameras 200 and/or the bottom RGB-D Camera 202. The dynamic obstacles present within the pre-defined distance of the aerial robotic device 106 are detectable in the stitched radial images/video frames and bottom images/video frames (i.e., the second depth map 1200) by using the depth information available from the second depth map 1200.

As discussed, the Fields of View of the radial RGB-D cameras 200 and the bottom RGB-D camera 202 collectively form a downwards oriented substantially hemispherical region which is centered around the aerial robotic device 106. The size of the substantially hemispherical region is determined by the Fields of View of the radial RGB-D cameras 200 and the bottom RGB-D camera 202 and their disposition around the aerial robotic device 106. For the purpose of the present implementation, it is assumed that all objects in the aerial movement volume 110, other than the aerial robotic device 106 are earthbound. In other words, the aerial robotic device 106 is the only object aloft in the aerial movement volume 110. Thus, there are no objects in the aerial movement volume 110 at an elevation greater than the aerial robotic device 106 that could not be detected by the radial RGB-D cameras 200 or the bottom RGB-D camera 202. However, the skilled person will acknowledge that the present embodiment is not limited to detection of earthbound obstacles. On the contrary, the present embodiment is also operable to detect airborne obstacles whose elevations are less than that of the aerial robotic device 106.

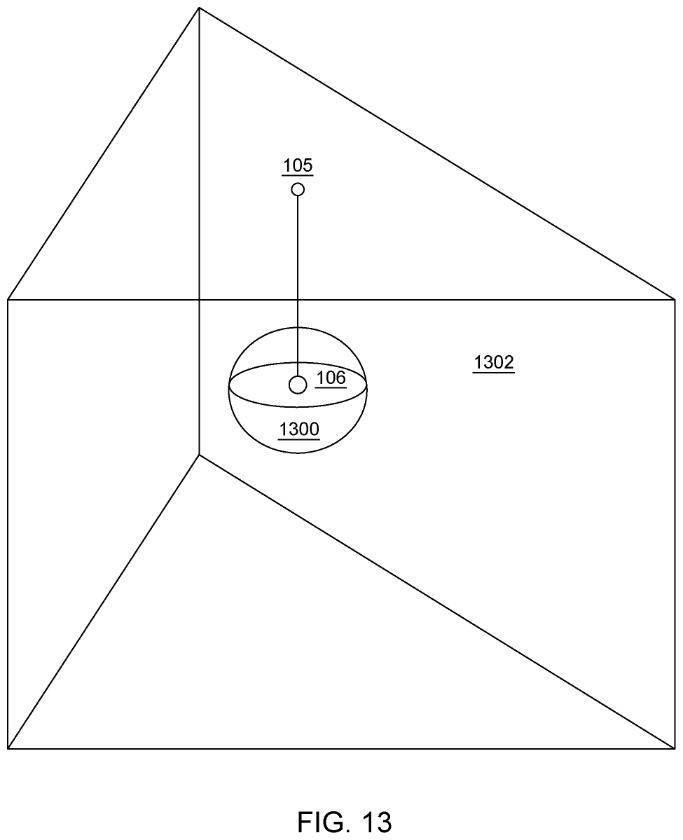

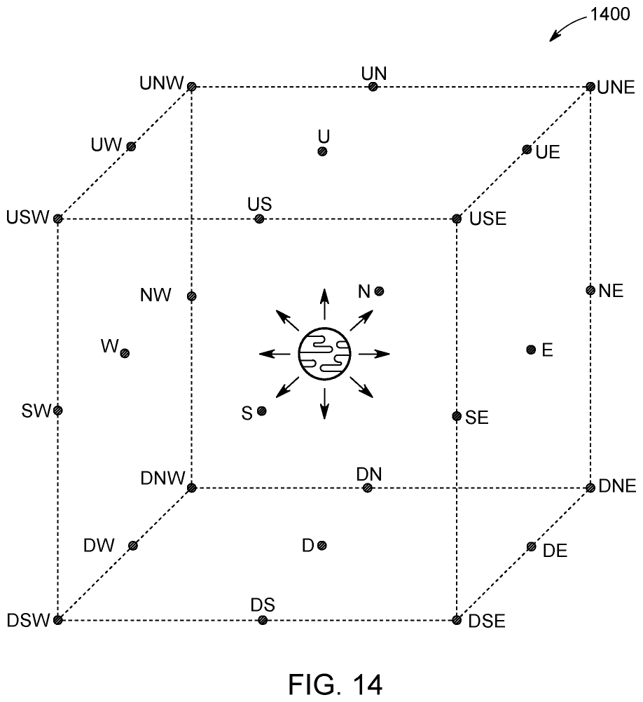

Referring to FIG. 13, the substantially hemispherical region (of radius d_{ow}, wherein d_{ow} may be for example 5 m) formed by the Fields of View of the radial RGB-D cameras 200 and the bottom RGB-D camera 202, and corresponding second depth map 1200, may be combined with a mirroring substantially hemispherical, upwards oriented region to form a substantially spherical region. This substantially spherical region will be referred to henceforth as visible zone 1300 since all objects in the lower hemispherical region thereof are observable and detectable by the radial RGB-D cameras 200 and the bottom RGB-D camera 202. By contrast, the rest of the aerial movement volume (which is beyond the Fields of View of the radial RGB-D cameras 200 and the bottom RGB-D camera 202) will be referred to henceforth as invisible zone 1302 since objects in this region are not detectable by the radial RGB-D cameras 200 and the bottom RGB-D camera 202. For clarity, only those dynamic obstacles that enter the visible zone 1300 are detectable by the radial RGB-D cameras 200 and the bottom RGB-D camera 202. Otherwise, unless a dynamic obstacle in the invisible zone 1302 remains there until the global environment map 1000 is next refreshed, the dynamic obstacle will not be detected.

The step 814 of the method 800 is followed by the steps 1810 and 1812 of the method 1800, with the step 1810 includes implementing a neural network architecture of the route planning unit 724 to determine an action to move the aerial robotic device 106 closer to the target location; and the step 1812 includes performing that action.

Since the visible zone 1300 is substantially centered around the aerial robotic device 106, the visible zone 1300 moves with the aerial robotic device 106. In other words, if the aerial robotic device 106 moves from a first location to a second location in the aerial movement volume 110, the visible zone 1300 will move accordingly. Thus, the scene captured by the radial RGB-D cameras 200 and the bottom RGB-D camera 202 at the first location may differ from the scene captured at the second location. In other words, on movement of the aerial robotic device 106 from the first location to the second location the contents of the stitched radial images/video frames and bottom images/video frames (i.e., the second depth map 1200) from the local mapping module 702 will change accordingly.

Since a global environment map 1000 is only acquired periodically, the images/video frames captured of the visible zone 1300 when centered at a given location represent the most up to date information regarding that location and the objects contained in the visible zone 1300 at that moment in time. On completion of the step 1812 of performing the action, the information from the stitched radial images/video frames and bottom images/video frames of the visible zone 1300 centered at the second location is added to the information of the corresponding region of the global environment map 1000, using a procedure as previously described in reference to description of the global map unit 712. Specifically, the step 1812 of performing the action is followed by the step 816 of the method 800 of updating the global environment map 1000 by converting into elevated locations those flat locations where obstacles have been subsequently detected in the visible zone around the aerial robotic device 106 at elevations in excess of the pre-defined threshold θ. Similarly, elevated locations that correspond with locations in which no obstacles have been subsequently detected in the visible zone around the aerial robotic device 106 are converted into flat locations.

Thus, the most recent information regarding the invisible zone 1302 at a given moment will be contained in the most recently acquired global environment map 1000; or in images/video frames acquired by the radial RGB-D cameras 200 and the bottom RGB-D camera 202 during the most recent pass of the aerial robotic device 106 over a region of the invisible zone 1302. Thus, in contrast with the visible zone 1300 where the stitched radial images/video frames and bottom images/video frames provide certainty regarding the presence and location of dynamic obstacles in the visible zone 1300 at any moment, there is limited certainty regarding the presence or location of dynamic obstacles in a given region of the invisible zone 1302 at a given moment, because the information regarding that region is unlikely to be sufficiently up to date to accurately represent the dynamic obstacles currently contained therein. Thus, the objects detected in the invisible zone 1302 are most likely to be non-moving obstacles or, more specifically, static obstacles.

Returning to FIG. 7, the navigation module 704 comprises a route planning unit 724. In some examples, the obstacle detection unit 722 is adapted to activate the route planning unit 724 on detection of obstacles thereby. The route planning unit 724 is configured to trace a route for the aerial robotic device 106 from the current location to the target location, avoiding the intervening one or more static obstacles and the one or more dynamic obstacles. Specifically, the route planning unit 724 is configured to determine a minimal adjustment to a current trajectory of the aerial robotic device 106 that enables it to avoid obstacles between it and the target location. The route planning unit 724 employs a deep Q-learning reinforcement algorithm implemented by a pre-trained adapted double Q-network (DDQN) architecture (as described in X. Lei, Z. Zhang and P. Dong, J. Robotics 2018 (12), 1-10, incorporated herein by reference) to calculate a stepwise navigation route to steer the aerial robotic device 106 to the target location while adapting to changes in the local environment to avoid intervening obstacles. Each step of the navigation route is expressed in terms of movement from a current location to a next location which brings the robotic device 106 closer to the target location. Each such location is represented by its co-ordinates in the previously described three dimensional navigation reference system (3D-NRS 400).

As would be appreciated, reinforcement learning is a framework for learning to solve sequential decision-making problems. Reinforcement learning is particularly useful for solving problems involving an agent interacting with an environment which provides numeric reward signals. A state is whatever information the agent has about the environment at a particular time. The reward of an action depends on all other actions made in the past, which are incorporated into the state of the environment at that time. The rewards an agent can expect to receive in the future depend on what actions it will take. Thus, the goal of the agent is to learn how to take actions (i.e., perform a task) to maximize the reward.

In deep Q-learning a deep neural network is used to learn an approximation of an action-value function (also known as a Q function) from state and action inputs. A Q function represents the long-term value of performing a given action in a given state, wherein this value is expressed in terms of the future rewards that can be expected. However, traditional Q-learning approaches suffer from large over-estimation of the Q function (i.e., a large positive bias) arising from inaccuracies in the initial estimates of the Q function at the start of the training of the neural network. This large positive bias strongly impacts the subsequent weight update process of the neural network.

Double Q-learning addresses this problem by replacing the single neural network of basic Q-learning with two neural networks, namely a Q-Estimation network (Q_{Est}) and a Q-Target network (Q_{Tgt}). The Q-Estimation network (Q_{Est}) selects the best action which, together with the next state achieves a maximum value from the estimated Q function. The Q-Target network (Q_{Tgt}) calculates the value from the estimated Q function with the action selected by the Q-Estimation network (Q_{Est}). Thus, the action selection process of basic Q-learning is decoupled from the action evaluation process, thereby alleviating the source of the bias in the initial estimate of the Q function. Furthermore, the hyperparameters of the Q-Estimation network (Q_{Est}) are updated sooner than those of the Q-Target network (Q_{Tgt}), thereby restraining the bias in the estimated Q function arising from a fast updating of the Q-Target network (Q_{Tgt}).

Referring to FIG. 14, the actions available to the agents in the route planning unit 724 comprise movements in 26 different directions defined by a cuboid 1400 surrounding the current location of the robotic device 106. Specifically, the directions of movement are set out in Table 1 below.

TABLE 1
Movement Directions of the aerial
robotic device 106

| Index | Tag | Direction |
|---|---|---|
| 1 | U | Straight up |
| 2 | D | Straight down |
| 3 | E | Straight ahead |
| 4 | W | Straight behind |
| 5 | S | Move to right |
| 6 | N | Move to left |
| 7 | NE | Move ahead and left |
| 8 | NW | Move behind and left |
| 9 | SE | Move ahead and right |
| 10 | SW | Move behind and right |
| 11 | UE | Move ahead and up |
| 12 | UW | Move behind and up |
| 13 | DE | Move ahead and down |
| 14 | DW | Move behind and down |
| 15 | DS | Move right and down |
| 16 | DN | Move left and down |
| 17 | US | Move right and up |
| 18 | UN | Move left and up |
| 19 | UNW | Move behind, left and up |
| 20 | USW | Move behind, right and up |
| 21 | DNW | Move behind, left and down |
| 22 | DSW | Move behind, right and down |
| 23 | UNE | Move ahead, left and up |
| 24 | USE | Move ahead, right and up |
| 25 | DNE | Move ahead, left and down |
| 26 | DSE | Move ahead, right and down |

In addition to these movement directions, the agents of the reinforcement learning model are also permitted to stop the movement of the aerial robotic device 106. Unless an action is a stop movement, the action is a fixed step of Δ (e.g., Δ=10 cm) in one of the above movement directions. Thus, the navigation module 704 is configured to support a total of 27 different actions.

In order to define a current state, the current location and the target location are represented as coordinates in the global environment map 1000. The route planning unit 724 is configured to apply to the current location and the target location (as defined in the 3D-NRS 400 system), a transformation mapping of the 3D-NRS 400 system to the global environment map.

This results in a transformed current location (X_{CL}, Y_{CL}) and a transformed target location (X_{TL}, Y_{TL}) respectively. A binary three dimensional matrix henceforth referred to as the augmented global map AGEM ε {0, 1}^{X}^{_{GEM}}^{×Y}^{_{GEM}}^{×3} is created by concatenating the global environment map with a first matrix and a second matrix, both of size X_{GEM}×Y_{GEM}.

Apart from the element at position (X_{CL}, Y_{CL}), which denotes the current location of the aerial robotic device 106, all the other elements of the first matrix are valued 1. The element of the first matrix at position (X_{CL}, Y_{CL}) is valued 0. Similarly, apart from the element at position (X_{TL}, Y_{TL}), which denotes the target location, all the other elements of the second matrix are valued 1. The element of the second matrix at position (X_{TL}, Y_{TL}) is valued 0. The input to the double Q-network comprises the augmented global map AGEM; the rescaled stitched radial images/video frames RAD and the rescaled bottom images/video frames BTM.

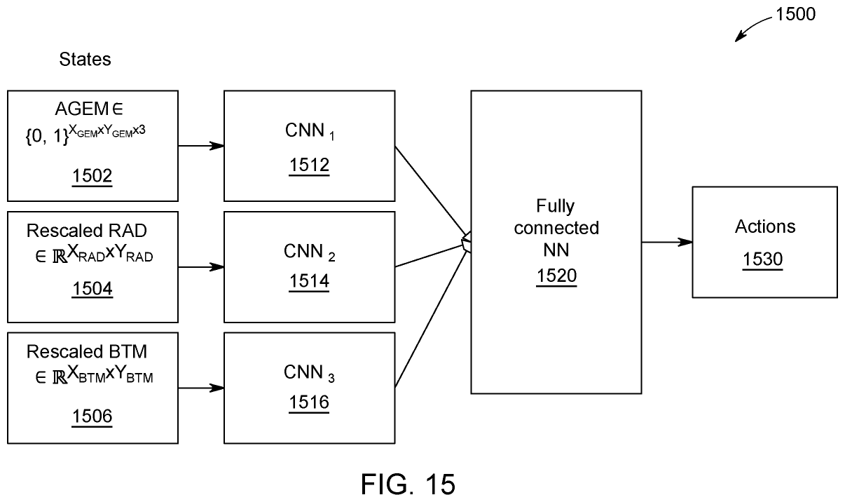

FIG. 15 illustrates a neural network architecture (as represented by the reference numeral 1500) employed by the Q-Estimation network and the Q-Target network of the double Q-network in the route planning unit 724. As illustrated, each of the three inputs, i.e., AGEM 1502, RAD 1504 and BTM 1506 is processed separately by convolutional neural networks namely CNN₁ 1512, CNN₂ 1514 and CNN₃ 1516. Herein, for describing the neural network architectures, a Layer Pair is defined to be two consecutive network layers in which a first network layer is a convolutional layer and a second network layer is a pooling layer. Henceforth, only the number of Layer Pairs existing in each network configuration are specified. In one embodiment, four Layer Pairs are used for CNN₁ 1512 and CNN₃ 1516; and five Layer Pairs are used for CNN₂ 1514.

The skilled person will understand that the above-mentioned network architecture is provided for illustration purposes only. In particular, the aerial navigation system of the present disclosure is not limited to the use of the above-mentioned network architecture. On the contrary, the aerial navigation system of the present disclosure is operable with any neural network architecture which estimates a Q function from the augmented global map AGEM; the rescaled stitched radial images/video frames RAD and the rescaled bottom images/video frames BTM; together with the movement directions of the aerial robotic device 106; and the reward function as will be described later; to enable the route planning unit 724 to calculate a stepwise navigation route to steer the aerial robotic device 106 to the target location while adapting to changes in the local environment to avoid intervening obstacles.

Similarly, the skilled person will acknowledge that the above-mentioned number of Layer Pairs is provided for illustration purposes only. In particular, the aerial navigation system of the present disclosure is not limited to the use of the above-mentioned number of Layer Pairs. On the contrary, the aerial navigation system of the preferred embodiment is operable with any number of Layer Pairs to enable the route planning unit 724 to calculate a stepwise navigation route to steer the aerial robotic device 106 to the target location while adapting to changes in the local environment to avoid intervening obstacles

Each of the CNN₁ 1512, CNN₂ 1514 and CNN₃ 1516 is characterized by its own set of hyperparameters regarding the convolutional layers and pooling layers. Further, as illustrated, the outputs from the last pooling layer of each convolutional neural network (CNN₁ 1512, CNN₂ 1514 and CNN₃ 1516 are transmitted to a fully connected neural network 1520. In an implemented setup, the fully connected neural network 1520 has two layers of neurons (wherein the first layer comprises 1024 neurons and the second layer comprises 128 neurons). Further, in the implemented setup, the fully connected neural network 1520 comprises an output layer of 28 output neurons (connected to the neurons of the second layer by a 128×28 matrix of weights), wherein the 28 output neurons correspond to actions 1530 (as described in Table 1 above).

The skilled person will understand that the above-mentioned number of layers and number of neurons in architecture of the fully connected neural network 1520 are provided for exemplary purposes only. In particular, the skilled person will acknowledge that the aerial navigation system of the present disclosure is in no way limited to the use of the above-mentioned number of layers and number of neurons in the architecture of the fully connected neural network 1520. On the contrary, the aerial navigation system of the present disclosure is operable with any number of layers and number of neurons in the fully connected neural network 1520 to enable the route planning unit 724 to calculate a stepwise navigation route to steer the aerial robotic device 106 to the target location while adapting to changes in the local environment to avoid intervening obstacles.

Herein, the reward for an agent is expressed in terms of an optimal (i.e., shortest distance) navigation path between the current location of the aerial robotic device 106 and the target location which avoids dynamic obstacles and static obstacles therebetween. Specifically, an initial trajectory is established between the current location of the aerial robotic device 106 and the eventual target location. For example, the initial trajectory may be a straight-line trajectory between the current location and the target location. The intersection of the initial trajectory with the periphery of the visible zone 1300 is then determined. Herein, this intersection point will be referred to henceforth as a local target.

Accordingly, the route planning unit 724 is configured to perform a search of the visible zone 1300 to identify one or more detours (represented by the actions determined by the neural network 1500) from the initial trajectory, which would allow the aerial robotic device 106 to avoid collision with obstacles (dynamic and static) between the current location of the aerial robotic device 106 and the local target. To assess the relative merits of potential detours, a reward/punishment function for the double-Q learning algorithm is defined as:

$$r = \{ \begin{matrix}1 * ( p ( {x}_{1} , {y}_{1} , {z}_{1} ) = g ( x , y , z ) ) \\ - 0.01 * ( p ( {x}_{1} , {y}_{1} , {z}_{1} ) \neq g ( x , y , z ) or p ( {x}_{1} , {y}_{1} , {z}_{1} ) \neq o ( x , y , z ) ) \\ - 1 * ( p ( {x}_{1} , {y}_{1} , {z}_{1} ) = o ( x , y , z ) )\end{matrix} , \qquad ( 25 )$$

where p is the current position of the aerial robotic device 106 and g is the location of the local target. Each detour [i.e., movement step (including the stop movement action)] from the initial trajectory has the same cost of 0.01. Collision with an obstacle incurs a punishment of −1, while reaching the local target confers a reward of 1. As the agent seeks to maximize the cumulative award during training, it gradually learns the Q function which represents the objective of avoiding obstacles while reaching the target location along a trajectory of shortest path length. To support the learning process, the double Q-learning algorithm employs the following loss function to establish the updates to the hyperparameters of the Q-Estimation network; and later the Q-Target network.

Lᵢ(θᵢ)=E[(r+γQ(s′,argmax(Q(s′,α′;θᵢ));θᵢ⁻)−Q(s,α;θᵢ))²] (26)

where θᵢ denote the hyperparameters of the Q-Estimation network; and γ is a discount factor.

Referring to FIG. 7, in the present embodiments, the navigation control unit 114 of the aerial navigation system 100 further comprises a simulator 730 communicably coupled with the route planning unit 724. The simulator 730 is configured to simulate the aerial movement volume 110 and generate obstacles of different sizes at different locations in the aerial movement volume 110. In keeping with the previous discussions of static obstacles or dynamic obstacles in the aerial movement volume 110, simulated obstacles are defined as stationary or moving cuboids. All simulated obstacles are designed to be touching the ground and each cuboid representations defined by five numbers, four of which define the x and y co-ordinates of points on the base of the cuboid; and the fifth number being the height h of the cuboid.

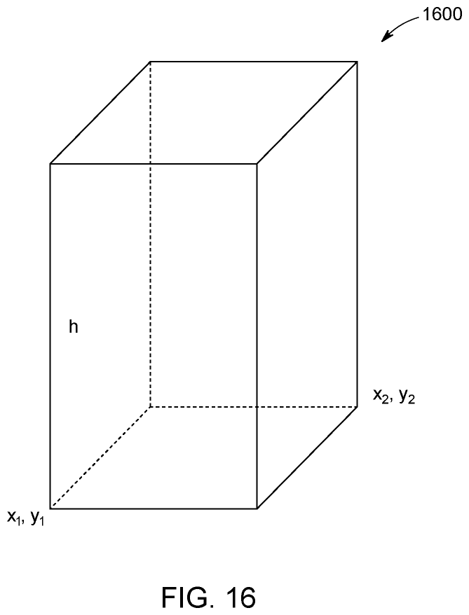

FIG. 16 illustrates a cuboid representation 1600 of a simulated obstacle. The movement of a moving cuboid is described by a linear equation, wherein the velocity of the moving cuboid is assumed to be uniform and rectilinear without acceleration. The equation of constant velocity motion is:

\vec{x}=\vec{x}₀+\vec{v}*t

wherein the velocity vector comprises an x and y component, such that \vec{v}=(vₓ, v_{y}).

Applying this equation to the initial coordinates of the base of the moving cuboid (x₁, y₁), (x₂, y₂) the coordinates of the moving cuboid at time t are:

(x₁+vₓ*t,y₁+v_{y}*t) and (x₂+vₓ*t,y₂+v_{y}*t)

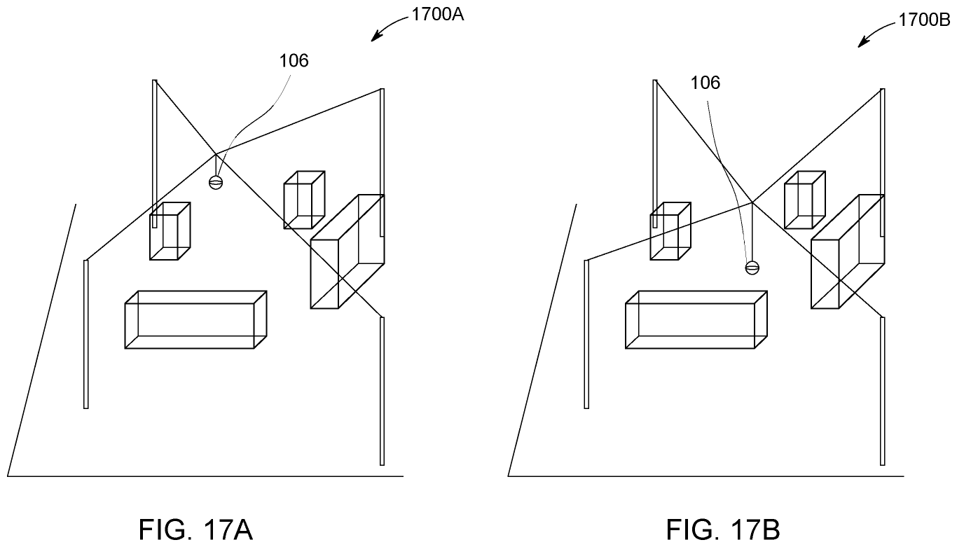

Referring to FIGS. 17A and 17B, different retail environments 1700A and 1700B represented in the simulator 730 are illustrated with stationary cuboids representing non-moving obstacles (e.g., shelves, pallets, etc.). The locations of such obstacles may be easily determined from plans of a candidate real-life store. For simplicity, the aerial robotic device 106 is represented as a sphere connected to the wires of the aerial navigation system 100 by a cable. The sphere can traverse the aerial movement volume 110 using the wiring system and the extension/retraction of the cable. To establish candidate trajectories of dynamic cuboids, trajectories of human moving about a candidate real-life store were determined from video footage recorded from the stores. Each such trajectory was divided into line segments; and the motion equation was determined therefrom. Because a constant velocity is required along a given line segment, the time stamps of the start and end of a given line segment are extracted from recorded video footage of the relevant trajectory. Using these time stamps an average velocity can be calculated for the line segment which is used to characterize the movement of a moving cuboid along the line segment.

The output of the simulator 730 at every simulation step represents a 360° panoramic projection using a well-known ray tracing algorithm modified to consider the depth of the ray-object intersection point instead of light intensity. The depth variable from the simulation environment coordinates are rescaled according to the scale of the simulation environment and transformed into a depth intensity using the depth camera depth-intensity mappings. The resulting output represents a close simulation of a real depth image captured by RGB-D cameras. This output is used to train the neural network architecture 1500 of the Q-Estimation network and the Q-Target network to learn the Q function to iteratively compute the discrete steps to avoid collision with obstacles during navigation of the aerial robotic device 106.

Once the neural network architecture 1500 is trained, the navigation module 704 is adapted to establish the co-ordinates of a next location of the aerial robotic device 106 as it moves towards the target location by adding the action output from the neural network 1500 to the co-ordinates of the current location of the aerial robotic device 106. The navigation module 704 is further adapted to transmit these co-ordinates to the management module 700. The management module 700 is adapted to receive the co-ordinates from the navigation module 704 and to use the received co-ordinates to control the electric motors 104 of the aerial navigation system 100, thereby causing the aerial robotic device 106 to execute the calculated next movement. The management module 700 is further adapted to store the received co-ordinates in the current location unit 714 as a representation of the current location of the aerial robotic device 106 following the execution of the calculated next movement.

In an embodiment of the present disclosure, the management module 700 is configured to use the co-ordinates received from the navigation module 704 to determine control parameters for at least one of the plurality of electric motors 104 driving the carrier device 105 and the at least one motor 109 driving the aerial robotic device 106 with respect to the carrier device 105 based on the computed discrete steps for the aerial robotic device 106.

The management module 700 further configures the plurality of electric motors 104 driving the carrier device 105 and the at least one motor 109 driving the aerial robotic device 106 with respect to the carrier device 109 to operate based on the respective control parameters therefor, to enable the aerial robotic device 106 to reach the target location. The plurality of electric motors 104 and the at least one motor 109 are synchronized through the shared real-time synchronization interface 118 of the navigation control unit 110 to ensure their simultaneous yet independent control and operation.

In the final stages of the navigation, generally, the current location should ideally be same as the target location as expressed by co-ordinates in the augmented global map. However, in practice, because of the coarse resolution of the augmented global map, the current location at the end of the navigation process, is unlikely to be perfectly aligned with the target location. Thus, to reach the exact targeted location, the management module 700 is configured to cause a final, linear move of the aerial robotic device 106 to be executed from its current location at the end of the navigation process to the target location without further guidance from the route planning unit 724.

Referring to FIG. 18, a flowchart of a method 1800 of navigating the aerial robotic device 106 to a target location while avoiding intervening stationary and dynamic obstacles is illustrated. FIG. 8 illustrates a flowchart listing steps involved in a method 800 for generating the GEM of the aerial movement volume 110 and detecting static obstacles and dynamic obstacles therein. As previously mentioned, the steps of the method 1800 are interleaved with the steps of the method 800. Thus, for simplicity and for ease of understanding, the following description of the method 1800 will include only brief references to associated steps in the method 800 because the steps of method 800 have already been discussed.

At step 1802, the method 1800 includes pre-training a neural network 1500, including Q-estimation network and a Q-target network, of the route planning unit 724. The step 1802 is followed by the steps 802, 804, 806 and 808 of the method 800, comprising:
the step 802 of performing a survey of the aerial movement volume 110 by the aerial robotic device 106 to establish the global environment map 1000 of the aerial movement volume 110;
the step 804 of receiving images/video frames of dense depth captured by the bottom RGB-D camera 202;
the step 806 of stitching the images/video frames captured by the bottom RGB-D camera 202 to generate a first depth map; and
the step 808 of detecting static obstacles in the aerial movement volume 110 based on an analysis of the first depth map.

The steps 802, 804, 806 and 808 of the method 800 are followed by the step 1804 of the method 1800 which includes determining the current location of the aerial robotic device 106 in the aerial movement volume 110. At step 1806, the method 1800 includes receiving a navigation instruction to move the aerial robotic device 106 to the target location. At step 1808, the method 1800 includes checking whether the current location of the aerial robotic device 106 substantially matches the target location. If the current location of the aerial robotic device 106 does not match the target location, the step 1808 of the method 1800 is followed by the steps 810, 812 and 814 of the method 800. Herein, the step 810 includes receiving a plurality of video frames or images from a plurality of radial RGB-D cameras 200 and the bottom RGB-D camera 202. The step 812 includes stitching the images/video frames captured by the radial RGB-D cameras 200 and further stitching them with images/video frames captured by the bottom RGB-D camera 202, to generate a second depth map 1200. Further, the step 814 includes detecting one or more dynamic obstacles within a pre-defined distance of the aerial robotic device 106, based on an analysis of the second depth map 1200, wherein the pre-defined distance is determined by the detection ranges of the radial RGB-D cameras 200 and the bottom RGB-D camera 202.

The steps 810, 812 and 814 of the method 800 are followed by the step 1810 of the method 1800 which includes implementing the neural network architecture 1500 of the route planning unit 724 shown in FIG. 7 using the global environment map 1000 and the visible zone 1300 to determine an action to move the aerial robotic device 106 closer to the target location while avoiding an intervening object. At step 1812, the method 1800 includes performing by the aerial robotic device 106, the action determined by the route planning unit 724.

The step 1812 of the method 1800 is followed by the step 816 of the method 800 which includes updating the global environment map 1000. This is followed by the step 1808 of the method 1800 which includes checking whether the current location of the aerial robotic device 106 substantially matches the target location.

In the event the current location of the aerial robotic device 106 substantially matching the target location, the step 1808 is followed by the step 1814 of the method 1800, which includes making a final linear move of the aerial robotic device 106, if required, to the target location.

Thereby, the present disclosure proposes an obstacle avoidance extension for the aerial navigation system 100 for the aerial robotic device 106 at least partially suspended from a plurality of wires 102, 107 coupled to a plurality of elevated anchor points, such as from the upright members 103, and provided with motors 104, 109 adapted to permit direct movement of the aerial robotic device 106. Herein, the aerial navigation system 100 navigates the aerial robotic device 106 in the presence of static and/or dynamic obstacles within the defined aerial movement volume 110 of the aerial robotic device 106. The aerial navigation system 100 described herein uses a reinforcement learning technique to calculate and execute an optimal navigation route to a target location which prevents collision with intervening obstacles.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. An aerial navigation system comprising:
an aerial robotic device moveable within an aerial movement volume and comprising one or more depth detecting sensors configured to capture image frames of a vicinity of the aerial robotic device within a field of view thereof;
a navigation control unit for navigating the aerial robotic device in the aerial movement volume, the navigation control unit configured to:
define a target location for the aerial robotic device in the aerial movement volume;
perform a survey of the aerial movement volume by the aerial robotic device in accordance with a pre-defined movement schema to generate a global environment map of the aerial movement volume;
analyze the global environment map to detect one or more static obstacles in the aerial movement volume;
stitch the captured image frames of the vicinity of the aerial robotic device to generate a depth map detailing presence or absence of objects with reference to a current location of the aerial robotic device;
analyze the depth map to detect one or more dynamic obstacles in the vicinity of the aerial robotic device;
re-scale the depth map to correspond to the global environment map of the aerial movement volume, wherein the current location of the aerial robotic device is represented as a co-ordinate in the global environment map;
trace a route for the aerial robotic device from the current location to the target location based on the detected one or more dynamic obstacles and the detected one or more detected static obstacles; and
navigate the aerial robotic device based on the traced route from the current location to the target location.

2. The aerial navigation system of claim 1, wherein the navigation control unit is configured to implement a neural network to trace the route, wherein the neural network is pre-trained to avoid collision with obstacles during navigation of the aerial robotic device.

3. The aerial navigation system of claim 2, wherein the navigation control unit is configured to pre-train the neural network by:
simulating the aerial movement volume;
generating obstacles of different sizes at different locations in the simulated aerial movement volume; and
executing simulation scenarios to generate training data for the neural network.

4. The aerial navigation system of claim 2, wherein the neural network is based on deep Q-learning reinforcement algorithm.

5. The aerial navigation system of claim 4, wherein a reward for the neural network is expressed as a shortest distance navigation path between the current location of the aerial robotic device and the target location avoiding the one or more static obstacles and the one or more dynamic obstacles therebetween.

6. The aerial navigation system of claim 1, wherein the aerial robotic device is suspended from a vertical wire connected to a carrier device, and wherein the aerial navigation system further comprises a plurality of electric motors mounted on upright members at a substantially same height from a ground and configured to drive the carrier device through a set of horizontal wires in a bounded horizontal plane mutually subtended by the plurality of electric motors, and at least one electric motor configured to drive the aerial robotic device with respect to the carrier device through the vertical wire, and wherein the aerial robotic device is moveable within an aerial movement volume defined between the ground, the plurality of upright members and the horizontal plane.

7. The aerial navigation system of claim 6, wherein the navigation control unit is configured to:
determine control parameters for at least one of the plurality of electric motors driving the carrier device and the at least one motor driving the aerial robotic device with respect to the carrier device based on the traced route for the aerial robotic device; and
configure the plurality of electric motors driving the carrier device and the at least one motor driving the aerial robotic device with respect to the carrier device to operate based on the respective control parameters therefor, to navigate the aerial robotic device based on the traced route from the current location to the target location.

8. The aerial navigation system of claim 7, wherein the navigation control unit comprises a real-time synchronization interface for synchronizing movements of the plurality of electric motors driving the carrier device and the at least one motor driving the aerial robotic device with respect to the carrier device respectively based on the respective control parameters therefor.

9. The aerial navigation system of claim 1, wherein the pre-defined movement schema comprises a looped zig-zag movement pattern.

10. The aerial navigation system of claim 1, wherein the global environment map of the aerial movement volume is a binary-valued two dimensional map of the aerial movement volume.

11. A method for navigating an aerial robotic device movable within an aerial movement volume, the aerial robotic device comprising one or more depth detecting sensors configured to capture image frames of a vicinity of the aerial robotic device within a field of view thereof, the method comprising:
defining a target location for the aerial robotic device in the aerial movement volume;
performing a survey of the aerial movement volume by the aerial robotic device in accordance with a pre-defined movement schema to generate a global environment map of the aerial movement volume;
analyzing the global environment map to detect one or more static obstacles in the aerial movement volume;
stitching the captured image frames, by the one or more depth detecting sensors, to generate a depth map detailing presence or absence of objects with reference to a current location of the aerial robotic device;
analyzing the depth map to detect one or more dynamic obstacles in the vicinity of the aerial robotic device;
re-scaling the depth map to correspond to the global environment map of the aerial movement volume, wherein the current location of the aerial robotic device is represented as a co-ordinate in the global environment map;
tracing a route for the aerial robotic device from the current location to the target location based on the detected one or more dynamic obstacles and the detected one or more detected static obstacles; and
navigating the aerial robotic device based on the traced route from the current location to the target location.

12. The method of claim 11 wherein tracing the route comprises implementing a neural network, wherein the neural network is pre-trained to avoid collision with detected obstacles during navigation of the aerial robotic device.

13. The method of claim 12 wherein pre-training the neural network comprises:
simulating the aerial movement volume;
generating obstacles of different sizes at different locations in the simulated aerial movement volume; and
executing simulation scenarios to generate training data for the neural network.

14. The method of claim 12, wherein the neural network is based on deep Q-learning reinforcement algorithm, and wherein a reward for the neural network is expressed as a shortest distance navigation path between the current location of the aerial robotic device and the target location avoiding the one or more static obstacles and the one or more dynamic obstacles therebetween.

15. The method of claim 11 wherein the pre-defined movement scheme comprises a looped zig-zag movement pattern.

16. The method of claim 11 wherein the global environment map of the aerial movement volume is a binary-valued two dimensional map of the aerial movement volume.

17. A navigation control unit for navigating an aerial robotic device movable within an aerial movement volume, the aerial robotic device comprising one or more depth detecting sensors configured to capture image frames of a vicinity of the aerial robotic device within a field of view thereof, the navigation control unit configured to:
define a target location for the aerial robotic device in the aerial movement volume;
perform a survey of the aerial movement volume by the aerial robotic device in accordance with a pre-defined movement schema to generate a global environment map of the aerial movement volume;
analyze the global environment map to detect one or more static obstacles in the aerial movement volume;
stitch the captured image frames of the vicinity of the aerial robotic device to generate a depth map detailing presence or absence of objects with reference to a current location of the aerial robotic device;
analyze the depth map to detect one or more dynamic obstacles in the vicinity of the aerial robotic device;
re-scale the depth map to correspond to the global environment map of the aerial movement volume, wherein the current location of the aerial robotic device is represented as a co-ordinate in the global environment map;
trace a route for the aerial robotic device from the current location to the target location based on the detected one or more dynamic obstacles and the detected one or more detected static obstacles; and
navigate the aerial robotic device based on the traced route from the current location to the target location.

18. The navigation control unit of claim 17 further configured to implement a neural network to trace the route, wherein the neural network is pre-trained to avoid collision with obstacles during navigation of the aerial robotic device.

19. The navigation control unit of claim 18 further configured to pre-train the neural network by:
simulating the aerial movement volume;
generating obstacles of different sizes at different locations in the simulated aerial movement volume; and
executing simulation scenarios to generate training data for the neural network.

20. The navigation control unit of claim 18, wherein the neural network is based on deep Q-learning reinforcement algorithm, and wherein a reward for the neural network is expressed as a shortest distance navigation path between the current location of the aerial robotic device and the target location avoiding the one or more static obstacles and the one or more dynamic obstacles therebetween.
